(19) United States
(12) Patent Application Publication
(10) Pub. No.: US 2021/0209683 A1
(43) Pub. Date: Jul. 8, 2021

(54) SYSTEM AND METHOD FOR DYNAMIC NEGOTATIONS WITH MULITPLE PAYMENT OPTIONS

(71) Applicant: Fintainium, Inc., Jacksonville, FL (US)

(72) Inventors: Richard Jackman, Jacksonville, FL (US); Mark Dinkel, Jacksonville, FL (US); Simarpreet Singh, Ontario (CA)

(73) Assignee: Fintainium, Inc., Jacksonville, FL (US)

(21) Appl. No.: 16/812,340

(22) Filed: Mar. 8, 2020

Related U.S. Application Data
(60) Provisional application No. 62/957,844, filed on Jan. 7, 2020.

(51) Int. Cl. G06Q 40/04; G06Q 30/04; G06Q 20/40; G06Q 30/00; G06Q 50/18; G06Q 40/02

(52) U.S. Cl. CPC G06Q 40/04; G06Q 30/04; G06Q 40/02; G06Q 30/0185; G06Q 50/188; G06Q 20/4014

(57) ABSTRACT

An apparatus and method for improved communications between two parties which allows for users to make an offer to change the terms of an existing contract. For example, a Payor may use the apparatus and method to offer to their Payee a greater amount for a later payment date whereby a Facilitator may instead send the offer to a marketplace to assist the Payor to get the terms they need to run their business and to ensure the Payor gets paid on time in order to keep all parties viable while a Facilitator may collect fees on the transactions.

### RELATED APPLICATION DATA

This application claims the benefit of priority to Provisional Application No. 62/957,844, filed on Jan. 7, 2020. The entire contents of each of the above-identified applications are hereby incorporated by reference in their entirety.

### FIELD OF THE INVENTION

The present disclosure generally relates to a cloud based financial services platform that provides users with a variety of payment modalities, e.g., paper and other forms of check, ACH, virtual card, debit card, etc., a view to status of accounts payable, accounts receivable, purchase order creation and issuance, bad debt management and trade finance.

More specifically, the present disclosure generally relates to methods, systems, and computer program products relating to a cloud based financial services platform/system that provides users with the option add additional negotiations and/or payment methods, like 1) pay early for a reward e.g., a discount or 2) pay late for a penalty e.g., paying a premium on top of the original contracted amount.

### BACKGROUND

Conventional payment and/or disbursement systems require the manual processing of purchase orders. For example, in conventional methods, payment process involves significant human intervention, e.g., walking payables around in colored folders and finding the correct reviews and approvers, and submission to a payments clerk along with a file of supporting review and approvals.

### SUMMARY

This Summary introduces a selection of concepts in a simplified form in order to provide a basic understanding of some aspects of the present disclosure. This Summary is not an extensive overview of the disclosure and is not intended to identify key or critical elements of the disclosure or to delineate the scope of the disclosure. This Summary merely presents some of the concepts of the disclosure as a prelude to the Detailed Description provided below.

A system, method and non-transitory computer readable medium of at least one embodiment comprises a communication unit configured and/or programmed to separately receive account information from both a first user and a second user, wherein the account information includes at least i) an information identification or invoice number ii) an amount of a commodity (e.g., may also include line item detail), iii) a due date corresponding to the amount of the commodity, iv) identification information of the first user and v) identification information of the second user, a processing unit configured and/or programmed to: match the account information received from the first user to the account information received from the second user based on i) the information identification or invoice number, ii) identification information of the first user and iii) identification information of the second user, and assign a transaction to the matched account information. It should be note that matching the account information received from the first user to the account information received from the second user may also be based on any and all communications (e.g., to/from users) where the communications are related to said transaction. All communication units (offers, counteroffers, acceptances, rejections, assignments, and the like, (that are generated within and/or without the Core System/Platform, etc.) are recorded, stored, and/or maintained in a database (e.g., of the Core System/Platform) and are fully searchable and/or auditable, by transaction (and/or by identification number, and/or by user name, and/or etc.), to determine the validity and agreement on the negotiated terms of a transaction, by the Facilitator and/or a user (e.g., a user party to the specific transaction).

By the system (e.g., automatically) performing the matching to correspond the correct transaction between two users, the system may provide numerous benefits, for example reducing the processing need for checks and balances, the time wasted by user(s) looking for typographical and/or data entry mistakes, etc. Accordingly, this matching may allow for processing among transactional platforms to be faster, more accurate, provide additional checks and balances, and/or etc.

A system, method and non-transitory computer readable medium of at least one embodiment may also comprise a processing unit configured and/or programmed to: determine whether or not the amount of the commodity received from the first user numerically corresponds the amount of the commodity received from the second user, determine whether or not the amount of the due date received from the first user corresponds the due date received from the second user, wherein the communication unit is further configured and/or programmed to: assign and/or label the transaction as an inaccurate transaction and send: a request for new commodity amount data in the case that a determination was made that the amount of the commodity received from the first user did not numerically correspond to the amount of the commodity received from the second user, and/or a request for new due date information in the case that a determination was made that the amount of the due date received from the first user did not correspond to the due date received from the second user, wherein the transaction is assigned and/or label as an accurate transaction in a case that both a determination was made that the amount of the commodity received from the first user does numerically correspond to the amount of the commodity received from the second user, and a determination was made that the amount of the due date received from the first user does correspond to the due date received from the second user.

By the system (e.g., automatically) searching for inaccuracies in a transaction(s) between two users, the system may provide numerous benefits, for example reducing the processing need for checks and balances, the time wasted by user(s) looking for typographical and/or data entry mistakes, etc. Accordingly, this matching may allow for processing among transactional platforms to be faster, more accurate, provide additional checks and balances, and/or etc. It should be noted that the system may have a recursive manner in handling any and all inaccurate/nonmatching data as for example, the system will send out a request for corrected data every time it receives inaccurate data and may not stop (e.g., may not mark the transaction as accurate) until the all data is accurate (matched via all parties involved).

A system, method and non-transitory computer readable medium of at least one embodiment may also comprise a processing unit configured and/or programmed to: search a group of accurate transactions based on a criterion that no offers are pending, select a first transaction in said group of accurate transactions based on a Facilitator user input, wherein the first transaction includes a first amount due and a first due date.

By the system allowing a Facilitator user to search transaction, the system may provide numerous benefits, for example allowing the Facilitator user to initiate interaction between users making, for example, the user experience more desirable, more financially profitable and/or provide more business strength (by giving options for one or more parties to have benefits), etc.

A system, method and non-transitory computer readable medium of at least one embodiment may also comprise a communication unit configured and/or programmed (e.g., for the first user) to send an offer to the second user (negotiate) with a second amount due and second due date based on the Facilitator user input, wherein the second amount due is different than the first amount due, and the second due date is different than the first due date.

By the system allowing user(s) to make offers (counteroffers, negotiations (e.g., negotiate terms of payment), etc.), the system allows for numerous benefits like allowing a user to have more preferable payment options after they have already agreed to payments options that are no longer optimal at the time of the new offer made.

A system, method and non-transitory computer readable medium of at least one embodiment may also comprise a communication unit configured and/or programmed to send an offer to the second user with a second amount due and second due date based on the Facilitator user input, wherein the second amount due is less than the first amount due, and the second due date is earlier than the first due date.

By the system allowing user(s) to make offers (counteroffers, negotiations (e.g., negotiate terms of payment), etc.), the system allows for numerous benefits like allowing a user to have more preferable payment options after they have already agreed to payments options that are no longer optimal at the time of the new offer made.

A system, method and non-transitory computer readable medium of at least one embodiment may also comprise a communication unit configured and/or programmed to send an offer to the second user with a second amount due and second due date based on the Facilitator user input, wherein the second amount due is greater than the first amount due, and the second due date is later than the first due date.

By the system allowing user(s) to make offers (counteroffers, negotiations (e.g., negotiate terms of payment), etc.), the system allows for numerous benefits like allowing a user to have more preferable payment options after they have already agreed to payments options that are no longer optimal at the time of the new offer made.

A system, method and non-transitory computer readable medium of at least one embodiment may also comprise a communication unit configured and/or programmed to send an offer (counteroffers, negotiations (e.g., negotiate terms of payment), etc.) to the second user with a second amount due and second due date based on the Facilitator user input, wherein the second amount due is different than the first amount due, and the second due date is different than the first due date; and the communication unit is further configured and/or programmed to receive a response from the second user in response to said offer.

By the system allowing user(s) to make offers (counteroffers, negotiations (e.g., negotiate terms of payment), etc.), the system allows for numerous benefits like allowing a user to have more preferable payment options after they have already agreed to payments options that are no longer optimal at the time of the new offer made.

A system, method and non-transitory computer readable medium of at least one embodiment may also comprise a processing unit configured and/or programmed to: search a group of transactions based on a criterion that no offers (no counteroffers, no negotiations, no etc.) are pending, select a first transaction in said group of transactions based on a Facilitator user input, wherein the first transaction includes a first amount due and a first due date.

By the system allowing a Facilitator user to search transaction, the system may provide numerous benefits, for example allowing the Facilitator user initiate interaction between users making for example the user experience more desirable, more financially profitable and/or provide more business strength (by giving options for one or more parties to have benefits), etc.

A system, method and non-transitory computer readable medium of at least one embodiment may also comprise a communication unit configured and/or programmed to send an offer (and/or a counteroffer) to the second user with a second amount due and second due date based on the Facilitator user input, wherein the second amount due is different than the first amount due, and the second due date is different than the first due date; and the communication unit is further configured and/or programmed to receive a response from the second user in response to said offer.

By the system allowing user(s) to make offers, counteroffers, to negotiate the terms of payment, etc., the system allows for numerous benefits like allowing a user to have more preferable payment options after they have already agreed to payments options that are no longer optimal at the time of the new offer made.

A system, method and non-transitory computer readable medium of at least one embodiment where the response from the second user in response to said offer may be an acceptance of the offer (or a counteroffer, etc.), wherein a processing unit configured and/or programmed to: inform the first user that the transaction is transferred from the second user to the Facilitator user (e.g., a communication unit), and/or assign the transaction from the second user to the Facilitator user (e.g., via a communication unit).

By the system allowing user(s) to make offers (counteroffers, negotiations (e.g., negotiate terms of payment), etc.), the system allows for numerous benefits like allowing a user to have more preferable payment options after they have already agreed to payments options that are no longer optimal at the time of the new offer (or counteroffer, etc.) made. In addition, the system may also provide the Facilitator user to intervene and take the more optimal transactions (e.g., offers). It should be noted that the assignment of the transaction also provides at least the benefit that the user does not make arrangements outside of the platform for the payment and the Payee does not double collect, etc. Therefore, a transfer of assignment done automatically in the system is beneficial for at least the reason it will bind the Payee and Payor to the new agreement which may benefit the Facilitator user. It should also be noted that the system may also automatically notify (e.g., notification, a communication unit, etc.) any or all parties involved of the assignment and/or prompt each and every party involved in the transaction to acknowledge the assignment transfer.

A system, method and non-transitory computer readable medium of at least one embodiment wherein the Facilitator user having a Facilitator user account for receiving, holding and/or transferring funds, the first user having a first user account for receiving, holding and/or transferring funds, the second user having a second user account for receiving, holding and/or transferring funds, the processing unit configured and/or programmed to: transfer funds from the Facilitator user account to said second user account on or prior to said second due date, wherein said funds transferred from the Facilitator user account to said second user account corresponds to said second amount due.

A system, method and non-transitory computer readable medium of at least one embodiment may also comprise a processing unit configured and/or programmed to: transfer funds from the first user account to said Facilitator user account on or prior to said first due date, wherein said funds transferred from the first user account to said Facilitator user account corresponds to said first amount due.

A system, method and non-transitory computer readable medium of at least one embodiment may also comprise a processing unit configured and/or programmed to: process an offer (or counteroffer, etc.) sent from the first user to the second user, wherein the offer is a request to change a first amount due and a first due date of a first transaction to a second amount due and a second due date of the first transaction, and transmit to the Facilitator user information regarding said offer (e.g., or counteroffer, etc.).

A system, method and non-transitory computer readable medium of at least one embodiment may also comprise a processing unit configured and/or programmed to forward said offer (or counteroffer, or etc.) to the second user based on the Facilitator user input.

A system, method and non-transitory computer readable medium of at least one embodiment may also comprise a processing unit configured and/or programmed to: forward said second amount due and said second due date to a marketplace, wherein said marketplace incudes at least one marketplace user, said at least one marketplace user is not the first user, said at least one marketplace user is not the second user, and said at least one marketplace user is not the Facilitator user.

A system, method and non-transitory computer readable medium of at least one embodiment where at least one marketplace user may accept the offer (or counteroffer, etc.), the processing unit further configured and/or programmed to: inform the first user that the transaction is transferred from the second user to the Facilitator user and/or the at least one marketplace user, and/or assign the transaction from the second user to the Facilitator user and/or the at least one marketplace user.

A system, method and non-transitory computer readable medium of at least one embodiment where the Facilitator user and/or the at least one marketplace user having a Facilitator user account and/or a marketplace user account for receiving, holding and/or transferring funds, the first user having a first user account for receiving, holding and/or transferring funds, the second user having a second user account for receiving, holding and/or transferring funds, wherein the processing unit configured and/or programmed to: transfer funds from the Facilitator user account and/or the at least one marketplace user account to said second user account on or prior to said second due date, wherein said funds transferred from the Facilitator user account and/or the at least one marketplace user account to said second user account corresponds to said second amount due.

A system, method and non-transitory computer readable medium of at least one embodiment may also comprise a processing unit configured and/or programmed to: transfer funds from the first user account to said Facilitator user account and/or the at least one marketplace user account on or prior to said first due date, wherein said funds transferred from the first user account to said Facilitator user account and/or the at least one marketplace user account corresponds to said first negotiated amount due and/or due date.

A system, method and non-transitory computer readable medium of at least one embodiment may also comprise a processing unit configured and/or programmed to: send a different offer from the Facilitator user to said second user, wherein the offer is a request to change the first amount due and the first due date of the first transaction to a third negotiated amount due and/or a third due date of the first transaction.

A system, method and non-transitory computer readable medium of at least one embodiment wherein the third amount due may be different from the second negotiated amount due and due date, and the third due date may be different from the second due date.

Further scope of applicability of the present invention will become apparent from the Detailed Description given below. However, it should be understood that the Detailed Description and specific examples, while indicating preferred embodiments of the invention, are given by way of illustration only, since various changes and modifications within the spirit and scope of the invention will become apparent to those skilled in the art from this Detailed Description.

### BRIEF DESCRIPTION OF DRAWINGS

These and other objects, features and characteristics of the present disclosure will become more apparent to those skilled in the art from a study of the following Detailed Description in conjunction with the appended claims and drawings, all of which form a part of this specification. In the drawings:

FIG. 1 is a functional block diagram illustrating an example of an overall system arrangement of an Information Processing System, for example a web/cloud based user facing financial services platform, core system functionality, and backend systems to track platform activity and provide an auditable record of user interactions and activities System for financial services users according to at least one or more embodiments described herein.

FIG. 2 is an example of a functional block diagram/flow chart illustrating a Payee enrollment system and method according to at least one or more embodiments described herein.

FIG. 3 is an example of a functional block diagram/flow chart illustrating a New Payee enrollment system and method according to at least one or more embodiments described herein.

FIG. 4.1 is an example of a functional block diagram/flow chart illustrating a Negotiation Initialization via Payor Accounts Payable (AP) via a Payor method and system according to at least one or more embodiments described herein.

FIG. 4.2 is an example of a functional block diagram/flow chart illustrating a Payee Response to Negotiation Initialization via Payor method and system according to at least one or more embodiments described herein.

FIG. 4.3 is an example of a functional block diagram/flow chart illustrating a Payor Response to Payee's Review method and system according to at least one or more embodiments described herein.

FIG. 5 is an example of a functional block diagram/flow chart illustrating an Enrollment method and system (e.g., for a Payor) according to at least one or more embodiments described herein.

FIG. 5.1 is an example of a functional block diagram/flow chart illustrating a Negotiation Initialization Accounts Payable (AP) via a Payee method and system according to at least one or more embodiments described herein.

FIG. 5.2 is an example of a functional block diagram/flow chart illustrating a Payor Response to Negotiation Initialization via Payee Accounts Payable (AP) method and system according to at least one or more embodiments described herein.

FIG. 5.3 is an example of a functional block diagram/flow chart illustrating a Payee's Response back to Payor's Review Accounts Payable (AP) method and system according to at least one or more embodiments described herein.

FIG. 6.1 is an example of a functional block diagram/flow chart illustrating a Negotiation Initialization via Payee Accounts Receivables (AR) method and system according to at least one or more embodiments described herein.

FIG. 6.2 is an example of a functional block diagram/flow chart illustrating a Payor's Response to Negotiation Initialization via Payee Accounts Receivables (AR) method and system according to at least one or more embodiments described herein.

FIG. 6.3 is an example of a functional block diagram/flow chart illustrating a Payee's Response back to Payor's Review Accounts Receivables AR method and system according to at least one or more embodiments described herein.

FIG. 7.1 is an example of a functional block diagram/flow chart illustrating a Negotiation Initialization via Payor Accounts Receivable (AR) method and system according to at least one or more embodiments described herein.

FIG. 7.2 is an example of a functional block diagram/flow chart illustrating a Payee's Response to Negotiation Initialization via Payor Accounts Receivables (AR) method and system according to at least one or more embodiments described herein.

FIG. 7.3 is an example of a functional block diagram/flow chart illustrating a Payor's Response back to Payee's Review Accounts Receivables (AR) method and system according to at least one or more embodiments described herein.

FIG. 8 is an example of a functional block diagram/flow chart illustrating a Facilitator's management and/or control over the Dynamic Negotiation Process/Program (e.g., at least FIGS. 1-13) method and system according to at least one or more embodiments described herein.

FIG. 9 is an example of a functional block diagram/flow chart illustrating user interaction and communication using the Dynamic Negotiation Process/Program (e.g., at least FIGS. 1-13) method and system according to at least one or more embodiments described herein.

FIG. 10 is an example of a functional block diagram/flow chart illustrating the Dynamic Negotiations Process without the Facilitator actively participating in the Process according to at least one or more embodiments described herein.

FIG. 11a is an example of a functional block diagram/flow chart illustrating the Dynamic Negotiation Process/Program (e.g., at least FIGS. 1-13) with Facilitator interaction method and system according to at least one or more embodiments described herein.

FIG. 11b is another example of a functional block diagram/flow chart illustrating the Dynamic Negotiation Process/Program (e.g., at least FIGS. 1-13) with Facilitator interaction method and system according to at least one or more embodiments described herein.

FIG. 11c is an example of a functional block diagram/flow chart illustrating the Dynamic Negotiation Process/Program (e.g., at least FIGS. 1-13) with Facilitator initiation method and system according to at least one or more embodiments described herein.

FIG. 12 is a circuit diagram of one aspect of a computing device/controller 1000 that works in conjunction with the elements of the present disclosure

The headings provided herein are for convenience only and do not necessarily affect the scope or meaning of the claimed invention.

In the drawings, the same reference numerals and any acronyms identify elements or acts with the same or similar structure or functionality for ease of understanding and convenience. The drawings will be described in detail in the course of the following Detailed Description.

### DETAILED DESCRIPTION

This disclosure is not limited to the particular systems, devices and methods described, as these may vary. The terminology used in the description is for the purpose of describing the particular versions or embodiments only, and is not intended to limit the scope. Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

Descriptions of well-known starting materials, processing techniques, components and equipment may be omitted so as not to unnecessarily obscure the invention in detail. It should be understood, however, that the detailed description and the specific examples, while indicating (e.g., preferred) embodiments of the invention, are given by way of illustration only and not by way of limitation. Various substitutions, modifications, additions and/or rearrangements within the spirit and/or scope of the underlying inventive concept will become apparent to those skilled in the art from this disclosure. Embodiments discussed herein can be implemented in suitable computer-executable instructions that may reside on a computer readable medium (e.g., a hard disk drive, flash drive or other memory), hardware circuitry or the like, or any combination.

Before discussing specific embodiments, embodiments of a hardware architecture for implementing certain embodiments is described herein. One embodiment can include one or more computers communicatively coupled to a network. As is known to those skilled in the art, the computer can include a central processing unit (“CPU”), at least one read-only memory (“ROM”), at least one random access memory (“RAM”), at least one hard drive (“HD”), and one or more input/output (“I/O”) device(s). The I/O devices can include a keyboard, monitor, printer, electronic pointing device (such as a mouse, trackball, stylus, etc.) or the like. In various embodiments, the computer has access to at least one database over the network.

ROM, RAM and HD are computer memories for storing data and computer-executable instructions executable by the CPU. Within this disclosure, the term “computer-readable medium” is not limited to ROM, RAM, and HD and can include any type of data storage medium that can be read by a processor. In some embodiments, a computer-readable medium may refer to a data cartridge, a data backup magnetic tape, a floppy diskette, a flash memory drive, an optical data storage drive, a CD-ROM, ROM, RAM, HD or the like.

At least portions of the functionalities or processes described herein can be implemented in suitable computer-executable instructions. The computer-executable instructions may be stored as software code components or modules on one or more computer readable media (such as non-volatile memories, volatile memories, DASD arrays, magnetic tapes, floppy diskettes, hard drives, optical storage devices, etc. or any other appropriate computer-readable medium or storage device). In one embodiment, the computer-executable instructions may include lines of compiled C++, Java, HTML, or any other programming or scripting code.

Additionally, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

As used herein, the terms “comprises,” “comprising,” “includes,” “including,” “has,” “having” or any other variation thereof, are intended to cover a non-exclusive inclusion. For example, a process, article, or apparatus that comprises a list of elements is not necessarily limited to only those elements but may include other elements not expressly listed or inherent to such process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention.

The following terms shall have, for the purposes of this application, the respective meanings set forth below.

A “user” refers to one or more entities or people using any of the components and/or elements thereof as described herein. In some embodiments, the user may be a user of an electronic device. In other embodiments, the user may be a user of a computing device. Users described herein are generally either creators of content, managers of content, merchants, and/or consumers. For example, a user can be an administrator, a developer, a group of individuals, a content provider, a consumer, a merchant, a representative of another entity described herein, and/or the like.

An “electronic device” refers to a device that includes a processor and a tangible, computer-readable memory or storage device. The memory may contain programming instructions that, when executed by the processing device, cause the device to perform one or more operations according to the programming instructions. Examples of electronic devices include personal computers, supercomputers, gaining systems, televisions, mobile devices, medical devices, recording devices, and/or the like.

A “mobile device” refers to an electronic device that is generally portable in size and nature or is capable of being operated while in transport. Accordingly, a user may transport a mobile device with relative ease. Examples of mobile devices include pagers, cellular phones, feature phones, smartphones, personal digital assistants (PDAs), cameras, tablet computers, phone-tablet hybrid devices (“phablets”), laptop computers, netbooks, ultrabooks, global positioning satellite (GPS) navigation devices, in-dash automotive components, media players, watches, and the like.

A “computing device” is an electronic device, such as a computer, a processor, a memory, and/or any other component, device or system that performs one or more operations according to one or more programming instructions.

A “user interface” is an interface which allows a user to interact with a computer or computer system. A user interface may generally provide information or data to the user and/or receive information or data from the user. The user interface may enable input from a user to be received by the computer and may provide output to the user from the computer. Accordingly, the user interface may allow a user to control or manipulate a computer and may allow the computer to indicate the effects of the user's control or manipulation. The display of data or information on a display or a graphical user interface is a non-limiting example of providing information to a user. The receiving of data through a keyboard, mouse, trackball, touchpad, pointing stick, graphics tablet, joystick, gamepad, webcam, headset, gear sticks, steering wheel, pedals, wired glove, dance pad, remote control, and accelerometer are non-limiting examples of user interface components which enable the receiving of information or data from a user. A user interface (not illustrated) may arbitrate and include communication (generated within and without the platform) between a user and the electronic device 1000. For example, the user interface may include input interfaces such as a keypad, a button, a touch screen, a touch pad, a gyroscope sensor, a vibration sensor, and an acceleration sensor.

An “item”, a “product”, or “merchandise” are all goods and/or services that may be available for purchase. For example, the item, product, or merchandise may be an article of clothing, a fashion accessory, a household good, an electronic device, a car, an airline ticket, a hotel reservation, an event ticket, an insurance policy, property, repair services, and/or any other good or service. Items, products, and merchandise are generally used interchangeably herein, and therefore a discussion of one or more of the terms is meant to include any or all of the terms.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations include, but is not limited to: “for example,” “for instance,” “e.g.,” “in one embodiment.”

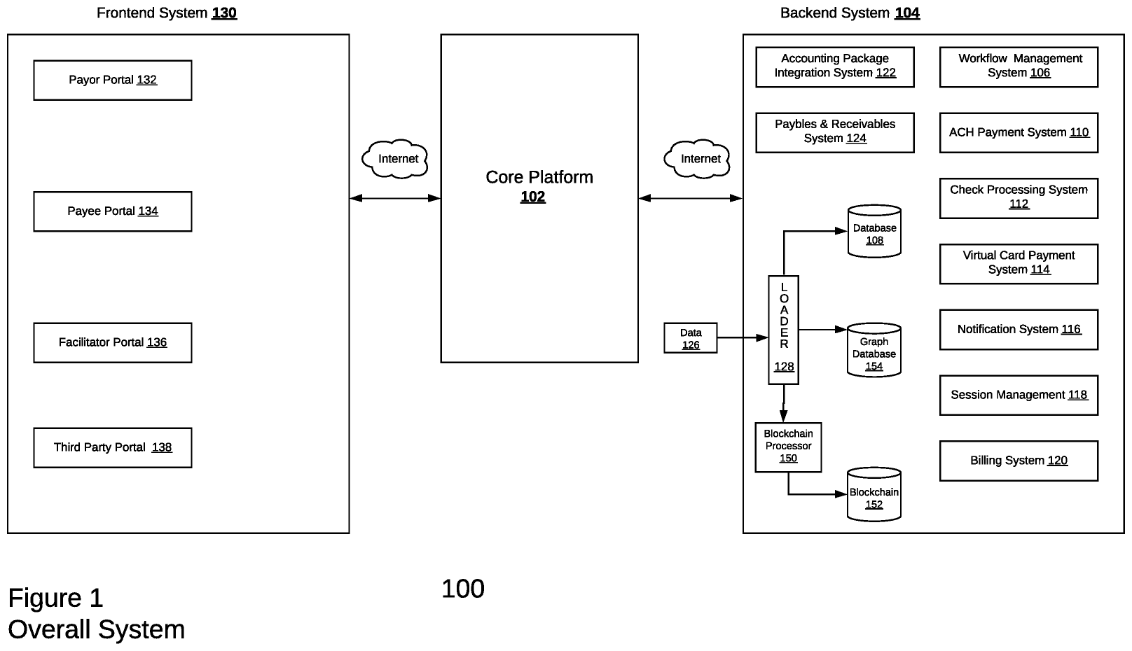

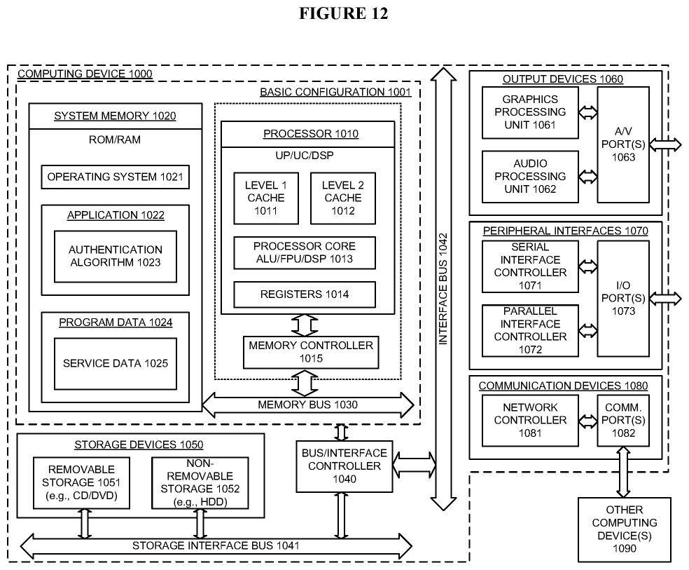

The functions of the various devices described herein with respect to at least FIGS. 1-11c represent an improvement in the functionality of general computing devices known in the art, and thus teach significantly more than existing technology, by providing an ability to efficiently. . . . Such devices may include a plurality of components, such as the components described herein with respect to at least FIG. 12. The functions of the various devices described herein with respect to at least FIGS. 1-11c also provide entities with an ability to conduct financial services with methods of providing options for negotiations, etc. that were previously nonexistent and would not be possible without the various computing devices, server devices and electronic devices herein. Such financial services with methods of providing options for negotiations, etc. would not be feasible without implementation of the devices described herein.

According to one or more embodiments, a first user (e.g., a Payor) may use the System/Platform 100 (as disclosed in for example FIGS. 1 to 11c) to make an offer to revise a term or terms of their mutually agreed upon contract or agreement (e.g., Accounts Receivable/Account Payables). While some examples in this disclosure are illustrated using Accounts Receivable/Account Payables, the system is not limited to Accounts Receivable/Account Payables. More specifically, any type of trade of services and/or goods, etc. would be applicable. For example, if a contracting company has multiple building permits pending the county government for approval, the contracting company could make an offer to expedite handling of a permit(s) for additional fees, and/or an offer to delay handling of a permit(s) for credits, and/or delaying certain permit(s) for expediting other permit(s). Similarly, the county government may counter the contractor's offer with a new offer.

According to one or more embodiments, the disclosure is not limited to an offer to change of a term(s) of an agreement (e.g., of an Account Receivable and/or an Account Payable) for a benefit (e.g., make the due date of a payment earlier than agreed upon (e.g., a benefit for the Payee)) and/or for a penalty (e.g., an additional premium on the amount due (e.g., a benefit for the Payor)). For example, according to one or more embodiments, an offer may also be a request to pay in multiple payments and/or times (2, 3, . . . x number of payments—similar to financing a loan with monthly payments) for a discount and/or additional premium on the amount due. More specifically, one example would to apportion of the amount due into payments before and/or during and/or after the agreed upon time for a discount and/or additional premium on the amount due.

In another example, an agreed upon arrangement may be to pay X dollars on a Date of DD/MM/YYYY where a user may request to pay X/2 dollars (or a first portion of the amount due) Z days or months (or some time period) before the Date of DD/MM/YYYY and pay X/2 dollars (or the remainder portion of the amount due) Z days or months (or some other time period) after the Date of DD/MM/YYYY for a total discount, and/or a total premium, and/or for a total flat fee (could be collected by the Facilitator only or shared with the second user), and/or for no fee, and/or etc. (including a combination thereof). The user may also offer to pay X dollars on a Date of DD/MM/YYYY where a user may request to pay X/2 dollars (or a first portion of the amount due) Z days or months (or some other time period) before the Date of DD/MM/YYYY for a benefit (or discount) while paying X/2 dollars (or the remainder portion of the amount due) Z days or months (or some other time period) after the Date of DD/MM/YYYY for a penalty (or premium).

According to one or more embodiments, the Facilitator may collect a portion of the amount due (from one or more parties on the transaction); and/or a portion of the premium (from one or more parties on the transaction); and/or collect a flat fee per transaction, a flat fee per offer, a flat fee per account (e.g., monthly fee), and/or etc. (from one or more parties on the transaction).

It should be noted that payments collection may be made for example, by debiting the payor's bank and/or other financial account, and/or by ACH, virtual card and/or other payment modality, including without limitation other goods and/or services, as the parties may agree.

According to one or more embodiments, a user may request their exact terms that they desired changes for the exact benefit/penalty they desire to be presented. Similarly, the second user may counter in the same fashion.

According to one or more embodiments, a user may be presented with a graphical presentation on a sliding scale (or the like) for making a request of offer. For example, an incremental sliding scale having a 1% premium for 1-month delay, 2% premium for 2-month delay, 3% premium for 3-month delay, etc. (and/or 1% discount for 1-month pay early, 2% discount for 2-month pay early, 3% discount for 3-month pay early, etc.) may be presented to the user along with the currently agreed upon due date and/or amount due (and/or any other terms). The sliding scale presented to the user may be pre-programmed into the system by the Facilitator (and/or any user on the system (e.g., a Payee like a Vendor) with predetermined benefits, and/or predetermined penalties, and/or predetermined increments of times (x days early/late, etc.), and/or predetermined rates for loans, and/or predetermined funding.

According to one or more embodiments, the Core System/Platform may be include an automated feature that automatically scans/determines when an Account Receivable/Account Payable is at and/or above a certain (e.g., dollar) amount (meets and/or exceeds threshold), the system send an automated offer to one or more (or all) parties of the transaction with a predetermined pay early and/or a predetermined pay late for a predetermined benefit and/or a predetermined penalty.

According to one or more embodiments, if the offer sent by one user is accepted by another user, the new agreement is binding (new terms are binding). However, according to one or more embodiments, any and all offers that have been sent and/or have been agreed upon may require approval and/or final approval of the Facilitator to make the offer proceed and/or make the deal binding (even if the Facilitator made the offer, even if the Facilitator agreed to the offer, etc.). For example, according to one or more embodiments, once the offer sent by one user is accepted by another user, the deal is binding (or temporally binding between the two main parties) but the Facilitator may have a certain time period to cancel the binding agreement between to the two main parties (and/or the Facilitator may have a certain time period to cancel the binding agreement if the Facilitator sent the offer, and/or the Facilitator agreed to the offer, and/or etc.).

According to one or more embodiments, the Facilitator may have access right to assign any AR, AP, etc. from one user to another including themselves. For Example, the Facilitator may take possession of a user's outstanding receivable to satisfy any potential default.

It should be noted that the Core System/Platform may be programmed to have a work-flow option that may allow for a second “approver” on the system when an offer, counteroffer, etc. is made. For example, any and all users of the Core System/Platform may be deemed to have authority (by the Facilitator) to make approvals using the Core System/Platform. However, internal approvals may remain within the purview of each specific user. The Core System/Platform may allow a user(s) to be able to add as many approvers as necessary to facilitate and/or approve a (their) transaction.

According to one or more embodiment, once a user is ready to make payment (e.g., module/step 448) the user can transfer the payment as agreed upon via the Core System/Platform.

It should be noted that while the disclosure does not explicitly discuss the method of transferring monies from one user account to another user account, any commonly known methods/procedures may be used. For example, once a first user (or entity) needs to make payment to a second user (or entity), users may proceed to a payment process (e.g., the Payment Process 448) for a user to deduct/debit/credit/etc. monies from their account(s) like a bank account, a credit card, etc. (either automatically and/or manually via the Platform 100/102) in order to transfer such monies to another user (another user's account). Each user may also have an account(s) on the Platform 100/102 where each user can hold money, transfer money, loan money, etc.

Although the figures and the descriptions described herein may be referred to using language such as “one embodiment,” or “certain embodiments,” or “example embodiments,” or “at least one embodiment” etc., these figures, and their corresponding descriptions are not intended to be mutually exclusive from other figures and/or descriptions, unless the context so indicates. Therefore, certain aspects from certain figures may be the same as certain features in other figures, and/or certain figures may be different representations or different portions of a particular exemplary embodiment, and/or certain aspects may be used with other aspects even if not explicitly mentioned, etc. Furthermore, any feature disclosed in one embodiment may be useable in any other embodiment.

FIG. 1 is a functional block diagram illustrating an example of an overall system arrangement of an Information Processing System, for example a web/cloud based user facing financial services platform, core system functionality, and backend systems to track platform activity and provide an auditable record of user interactions and activities System for financial services users according to at least one or more embodiments described herein.

It should be noted that the terms Customer, Client and Payor may be used interchangeable in this disclosure. It should also be noted that the terms Vendor and Payee may be used interchangeable in this disclosure. In addition, it should be noted that a Payor at times may also be a Payee in the system (and vice versa) when for example, a user may access the system as a Payor for one or more transactions and/or as a Payee for one or more (other) transactions—similarly, any (known) user may also a third party user (investor) to the system and/or a financial process (e.g., a negotiation transaction). The Facilitator may also act a third-party inventor in regard to funding loans, etc. In addition, a user may be a known user (e.g., an authenticated account holder) or a non-known user (e.g., a non-authenticated account holder).

FIG. 1 is a Dynamic Payables (DP) System/Method (and/or a Dynamic Negotiation System/Method/Process) 100 that includes at least one Front-End System 130, at least one Core Facilitator System and/or Platform 102 and at least one Back-End System 104. While FIG. 1 illustrates one Front-End System 130, one Core Facilitator System/Platform 102 and one Back-End System 104, for illustration purposes, multiple Front-End System, multiple Core Facilitator Systems/Platforms and/or multiple Back-End Systems may be used. Communication via any nodes may be carried via use of any means including but not limited to the Internet.

The Front-End System 130 may include numerous Front-End modulates/interferences, for example, including and/or not limited to a Payor Portal 132, a Payee Portal 134, an Administer (and/or Facilitator) Portal 136, a Third-Party Portal 138, and/or etc. Each Front-End module/interference may be used for/assigned to each type of person and/or account holder to have access to their specific type of Portal. For example, (Customer(s), Client(s), and/or) Payor(s) may all access the System/Platform 100 (e.g., the Core Facilitator System/Platform 102) via a Payor Portal 132 while (Vendor(s) and/or) Payee(s) may access the same System (e.g., the Core Facilitator System/Platform 102) via a Payee Portal 134. However, a Payor may also be a Payee (and vice versa), so at least some Payors may be both a Payor and a Payee under the system (and hence at least some Payees may be both a Payor and a Payee under the system). In addition, the Administer (and/or Facilitator and/or Host of the Core Facilitator System/Platform) would access the same System including all aspects (e.g., all portals) of the system via a Administer (and/or Facilitator) Portal 136. A third party who desires to offer loans, funding, etc., would access the Core Facilitator System/Platform 102 via a third-Party Portal 138.

Regardless of the designation of the Portal name, each and every user (a payor, a payee, an administrator, etc.) may access the Dynamic Negotiation System to be involved in the Dynamic Negotiation Functionality/Method/Procedure/Process via a “Portal” access to the Core Platform 102.

It should also be noted that the each “Portal” may be merely an assigned right to each user/entity. In other words, it may be a single access point for any user like a terminal, GUI, etc. For example, a user goes to a URL address (or app, etc.) and logs into the system. After logging into the system, the user selects the type of transactions they desire to access, for example, paying a Payee, sending an invoice to a Payor, searching and selecting loans to negotiations and/or offer funds for transactions between Payor and Payee, etc. whereby the system enters the user in that “Portal” per se.

A Payor Portal 132 may be used for by a user that would be assuming the role of a Payor to interface with/in the Core Facilitator System/Platform. For example, a Payor Portal 132 may be used to permit a Payor to engage with a Payee (or vice versa) through Dynamic Payment (and/or Negotiation) Functionality on/through the Core Facilitator System/Platform 102. The Core Facilitator System/Platform may include the entire range of activities a user can perform on it. Those activities include at least five pillars of the System/Platform: (1) purchase order creation and issuance, (2) account payable management, (3) accounts receivable management, (4) bad debt management, and (5) trade finance capability, etc.

Accordingly, even if one or both of a Payor and a Payee are a user of the Core Facilitator System/Platform 102, either party may conduct a business/financial process(es) and/or negotiations with the other via a Core Facilitator System/Platform. This Core Facilitator System/Platform 102 is a System/Platform where the Facilitator may charge fees, etc. for facilitating transactions/negotiations (e.g., Dynamic Negotiation Functionality). Herein, a/the Facilitator may also be referred to as a/the Host. Similarly, the Facilitator may also collect a fee based on allowing a third-party Investor to assist in the transaction (e.g., between a Payor and a Payee) by providing a loan, etc. Of course, the system may also be designed to allow the Facilitator the first right to provide the loan prior to offering such an opportunity to third-party Investors.

A Payee Portal 134 may be used by a Payee for entry into the Core Facilitator System/Platform. For example, a Payee Portal 134 may be used to permit a Payee to engage with a a Payor(s) through Dynamic Negotiation Functionality on the System/Platform entry point in the Core Facilitator System/Platform. The System/Platform's entry point is a portal where a user can authenticate his/her authority to use the Core Facilitator System/Platform, enters the Core Facilitator System/Platform, and perform functions there, e.g., make a payment, negotiate the terms of a payment (early pay for a discount; late pay for a premium), payment via cryptocurrency for a premium/discount; payment via derivative securities instruments, payment via commodities, e.g., gold, silver, etc. incorporate the concept that the third-party can take on the obligation to pay and/or turn the obligation over to the market place/exchange for payment/financing/fund sourcing and commoditization, trenching, securitizing or further manipulation of the underlying payment obligation. Accordingly, the third-party can intercede in the process to make offers to either Payors and/or Payees for payment for a fee that the third-party collects for facilitation.

Numerous benefits can be provided by providing a system where a user can request an early payment for a reward, a late payment for a penalty, a reward and/or penalty for changing certain terms of the agreement (change in currency, change in payment type, etc.), etc. For example, a Payee may need their invoices paid as soon as possible to show potential investors that their company is very liquid/profitable so they may desire to reward a Payor to pay immediately. Another example may be that a Payor currently does not have any or much liquid assets but will get a significant amount funding after the due date of an invoice(s) so the Payor may desire to delay payment for a penalty. In addition, a Payee may have a vested interest in a certain type of currency (e.g., a certain type of cryptocurrency) and the Payee is willing to give the Payor a reward (e.g., lessor payment) if the Payee pays the amount due via the Payor's desired currency instead of the currency that was agreed upon. Accordingly, there are numerous benefits to the System/Method according to one or more embodiments.

An Administer (and/or Facilitator) Portal 136 may be used for an Administer (and/or a Facilitator) entry into the Core Facilitator System/Platform. The Administer Portal 136 may allow an Administer/Facilitator to perform various functions on the Core System/Platform, e.g., programming the Core System/Platform. For example, an administrator has access to the Core System/Platform via the Administer Portal 136 to carry out functions of what administrators do; e.g., fix bugs, change configurations, assist in user problems, upload additional feature/functionality. Furthermore, the Administer Portal 136 (automatically, via instructions of the Administrator, etc.) permits the Core System/Platform 102 to do numerous functions like Platform upgrades, change/add/subtract Platform features and functionality, perform Platform maintenance, manage governance of Platform usage by Payor and/or Payee groups, etc.

The Administer (or Facilitator) Portal 136 may also be used for the Facilitator to get access to all the user accounts (the Payors and Payees accounts, third-party accounts, vendor accounts, etc.) in order to offer incentives for transactions, to start negotiations, to have the right to offer (financial) options/alternatives (e.g., loans, fund sourcing, etc.) to the Payor, etc. In addition, a Facilitator may interject and/or intervene in any and all parts of the negotiations, from start to finish and even if negotiations haven't even started or have already ended. The Core System/Platform may send a notification to the Facilitator at a predetermined time(s) (e.g., when an offer is made, when a counteroffer is made, when an offer/counter is rejected, when fund sources is requested, etc.) when Facilitator intervention is ideal.

For example, a Facilitator may start/initiate an offer for paying (an account balance) early for a discount (e.g., to the Payee, to the Payor, etc.), and/or a Facilitator may review any and all offers (e.g., to the Payee, to the Payor, etc.) prior to the receiving party actually receiving the offer so that the Facilitator has first right to accept and/or decline and/or counter any and all offers. Accordingly, the Facilitator, for example, may be able to route a user's (e.g., Payor's) offer (for early pay, late pay, etc.) to a specific third-party investor (or some/all third-party investors using the system) instead of the intended Payee or to a Marketplace for the offer to have access to a larger audience to bid on the offer making it a profitable commodity. In addition, the Facilitator may intercept an offer (e.g., to the Payee, to the Payor, etc.) and choose to decline it, accept it, make a counteroffer, and/or etc.

Numerous benefits can be provided by providing a system where a Facilitator can interject in a transaction. For example, the Facilitator may benefit from offering a Payor delayed payment for an additional fee because the Facilitator may have available capitol to use and hence cash in by collecting the additional fee. In addition, the Facilitator may collect a fee from each transaction in addition to intercepting and accepting an offer from one party to another in order to accept an offer with a higher additional fee collected from the Payor while negotiating a lower fee with the Payee (thereby collecting a transaction fee and collecting the difference between the fees agreed upon on each side of the transaction).

The Core System/Platform 102 may be used at least as a communication platform that supports each of the Front-End Portal(s), each of the Payor—Payee exchanges (e.g., via internet connectivity), etc.

In (and/or in conjunction with) the Back-End System 104, data 126 (like invoice data, etc.) is sent from any of the Portals (e.g., Payor portal(s) 132) and/or from the Core System/Platform 102 as an intermediate node. Accordingly, there is a Payee portal 134 where a Payee can find the status of its receivable, etc. and a Payor portal 132 where the Payor can view all payables, determine the status of its payables, etc. However, the Administrator portal 136 is accessible only by the Platform Administrator, i.e., employees and/or contractors that are approved/authenticated by the third party. The Loader 128 may be used to update numerous modules. For example, the Loader 128 may be used to update Backend Systems databases 108 of the Core Platform 102, the Graph database(s) 154 of the Core Platform 102, etc. The updating assist in keeping the database(s) 108 and the Graph database(s) 154 updated, for example, regarding the status and ultimate resolution of Payor—Payee payment negotiations options like fast pay negotiations and/or on time pay negotiations and/or late pay negotiations, etc. It should be noted that data 126 (e.g., invoice data) may include due date, amount due, and changes in the payment amount and due date based on Payor—Payee Platform based negotiations about the terms of payment (e.g., amount(s) due, when payment is due, etc.).

In or in conjunction with Graph Database 154, a Graph Database allows the Core system to store any and all information that the Core System has access to, for example, conversation and transactional information to and/or from any system user (e.g., conversation and transactional information between payor and payee), metadata regarding the transaction and conversation, and any other data that could be associated with the entire and/or part of the negotiation process. The data in Graph Database is then used to dynamically correlate, retrieve and process the information to find relationships and future value for future negotiations.

The Loader 128 may be used to interact with the Blockchain 152. In or in conjunction with Blockchain 152, the Blockchain 152 will receive the information from the blockchain process which in turn will store the information in a 256-bit hash for later retrieval The Blockchain Process 152, via a Blockchain Processor 150, will sign the payor and payee with their own respective RSA cert for each interaction between the two parties, which then will be sent to the Blockchain 152.

The Back-End system may include an Accounting package integration system/module 122. More specifically, the Core System/Platform may be integrated with a Payor and/or Payee accounting system (e.g., the Accounting package integration system 122). The Accounting package integration system 122 may be for example, SAP, Oracle (NetSuite), QuickBooks, etc.

In addition, the Back-End system may include a Payables & Receivables System/Module 124. More specifically, the Core System/Platform is integrated with the Payables & Receivables System/Module 124 for a Payor functionality to allow for money/fund exchange/transfer, payments, etc. The functionality of the Payables & Receivables System/Module 124 may allow for the System/Platform 100 to document in an auditable fashion the Payor's payment obligations regarding an amount(s), a Purchase Order(s), a Work Order(s), an invoice number(s), a bill of lading number(s), other document(s) relating for example to the payment obligation(s), payment timing(s)/date(s), and/or etc.

The Back-End system may also include a Workflow Management System/Module (e.g., a Payor Workflow Management System/Module 106). The Core System 102 may define intended Payor workflow processes, e.g., from entry of a payable into the Payor's accounting system through each review, approval, and execution of payment touchpoint within the Payor's organization. The management may be via single or multiple touch points, one or a plurality of reviewers, and one or a plurality of approvers, one or a plurality of payment actions, etc. The Core System 102 may integrate any, some and/or all of the management processes with functionality of the accounting system (e.g., modules 122 and/or 124).

Further, the Back-End system may include an Automated Clearing House (ACH) payment system/module 110. The Core System 102 can enable Payor payment through ACH functionality. The Core System 102 may integrate with every ACH payment mode and/or execute payment(s) according to the Payee's decision regarding which the specific ACH payment mode by which Payee chooses to be paid. The ACH payment system/module 110 may be pre-programed with default setting/parameters, for example, if a Payee does not elect a payment method, the default payment method may be (pre-programmed to be) the check processing system 112.

In addition, the Back-End system may include a Check Processing System/Module 112. Because most payments today are made by check the check processing system may be (pre-programmed to be) the default payment method used by the System 100. The Core System 102 enables Payor payment through paper checks (in addition to electronic checks, ACH transfer, and the like).

For example, the Core System 102 may integrate with the paper check payment mode and executes payment according to the Payee's decision regarding the selection of payment mode and/or having selected the check payment mode. In the absence of Payee electing the Payee preferred method like ACH, virtual card, or other developed payment methods, the check processing systems is automatically defaulted for use. Accordingly, if the Payor selects the paper check provider, the Core System/Platform enables the Payor payment through multiple multi-check runs and single check writing.

The Back-End system may also include a Virtual Card Payment System/Module 114. The Core System 102 can enable Payor payment through virtual card issuance functionality. For example, the Core System 102 can integrate with every virtual card payment mode and execute payment(s) according to the Payee's decision regarding the Payee's selected payment mode. The Core System 102 can also enable Payor's payment through issuance of virtual cards, prepaid cards, and/or the like. The Virtual Card Payment System/Module 114 may be pre-programed with default setting/parameters, for example, if a Payee does not elect a payment method, the default payment method may be (pre-programmed to be) the check processing system 112.

In addition, the Back-End system may include a Notification System/Module 116. For example, via notifications from the Notification System/Module 116 (and/or the Core Platform/System), a Payor(s) and/or Payee(s) may be notified of payment(s), payment method(s), payment amount(s), payment date(s), associated PO, WO, Bill of Lading, any other associated documentation through an auditable transaction trail(s), and/or any other notification of information/data desired to be programmed into the system 100.

Via the Notification System/Module 116 (and/or the Core Platform/System), Payor may be notified that Payee has elected to be paid via the Core Platform/System. Following the Payee election to receive payment via the Core Platform/System, the Payor makes payment in accordance with Payor—Payee Platform managed negotiation regarding invoice payments term, i.e., (1) early invoice payment where Payee's invoice is paid at less than face amount which both parties have agreed upon during the negotiations, i.e., a discount, (2) full payment of the invoice face amount in accordance with the Payor—Payee contract (e.g., where no negotiations were made, negotiations failed, etc.), or (3) late payment by Payor with a premium which both parties have agreed upon during the negotiations, i.e., an increase in the invoice face amount.

Further, the Back-End system may include a Session Management Module 118. The Session Management component of management of the system. For Example, the Session Management component may ensure that Payor and Payee are active on the Portal during their specific negotiation phase. Furthermore, the Session Management component may terminate a session (time out a session) based on an occurrence(s) like a Payor or Payee failing to timely complete the transaction.

The Back-End system may also include a Billing System/Module 120. The Billing System/Module may be updated and maintained to store information like payment information, etc. For example, the Billing System/Module 120 may be updated with information like payment information corresponding to a payment transfer from a Payor to a Payee, payment information corresponding to a payment made as a Payee receivable, etc. In the case where the Billing System/Module is updated with information, the Billing System/Module may require all data including associated PO, WO, Bill of Lading, and/or other associated documentation to be received and stored through an auditable transaction trail.

Also, the Back-End system may include a Loader 128. The Loader may receive data like Invoice data and/or Transaction data, including associated PO, WO, Bill of Lading, and/or other associated documentation whereby the Loader can then prepare the database 108 for updates.

The Back-End system may include one or a plurality of Core System/Platform database(s) which may be updated to reflect for example Payor and/or Payee transaction status, e.g., enrollment, payment/receivable (bank) information, Payor and Payee specific information, e.g., change of address, as well as transaction data including PO, WO, Bill of Lading, and other associated documentation, etc. Method(s) of payment, date(s), amount and related information may also be included/stored in database 108.

Duplication of drawing element(s) in other Figure(s) may not be discussed in detailed or not at all, instead duplicate element(s) from one figure may have some and/or all of the attributes as discussed in regard to the other Figure(s).

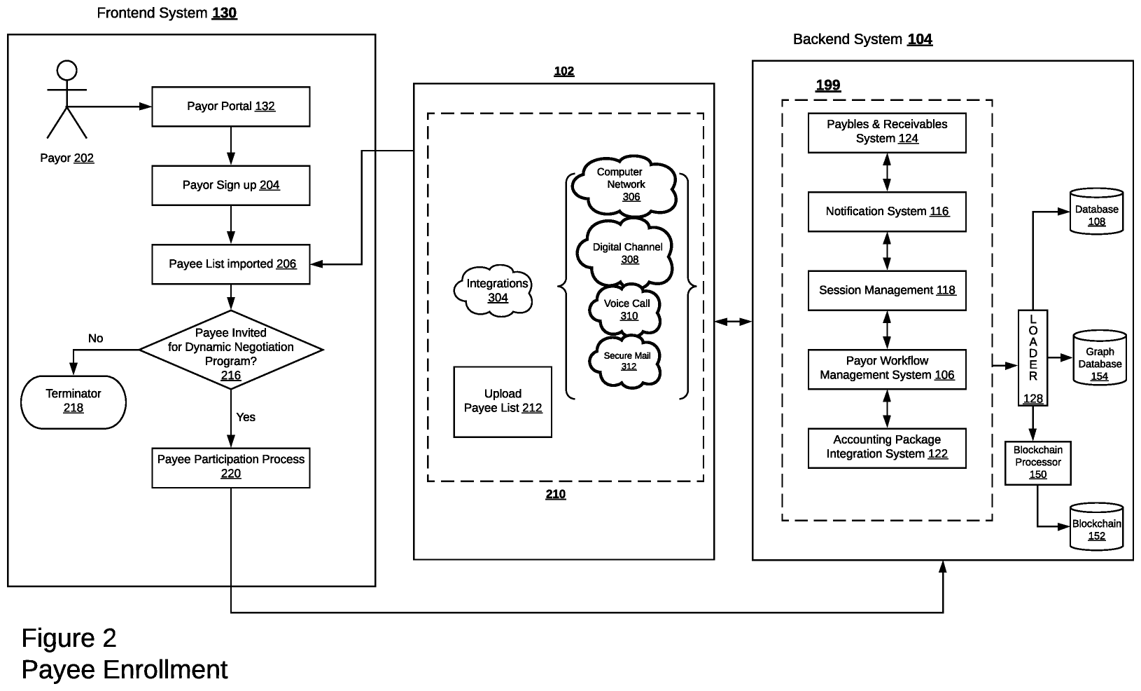

FIG. 2 is an example of a functional block diagram/flow chart illustrating a Payee enrollment system and method according to at least one or more embodiments described herein. For example, FIG. 2 illustrates how a user (e.g., a Payee, a Payor, etc.) may enroll in the system.

In the Front-End System 130, authentication of a first user (e.g., Payor 202) may be provided. The Payor 202 and/or, for example, an individual employee/representative of the Payor 202 may authenticate his/her authority to enter into the Payor Portal 132 through authentication (e.g., a two-factor authentication process) for access to the System/Platform 102.

After an authentication process, the Payor enters/accesses the Payor portal 132 in order to access/use to be able to use the System/Platform (e.g., System/Platform 100/System/Platform 102).

In module/step 204, enrollment may be performed where the Payor enrolls to use the System/Platform (e.g., System/Platform 100). For example, the Payor 202 provides data like company name, EIN, physical address, email address, contact name, contact phone number, bank(s) (bank(s) the Payor 202 intends to use via the Platform 100), including bank name, address, bank EIN, routing number(s) and Payor bank account number(s), etc.

In module/step 206, the Payor 202 may download (import, upload, revise, replace, and/or etc.) information like their Payee list and Payor General Ledger into/from the database 108. For example, in module/step 206, the Payor 202 may download and/or access a Payee list whereby the downloaded/accessed Payee list is associated with that particular Payor 202 (e.g., list A being accessed/downloaded for a first Payor 202a while list B being accessed/downloaded for a second Payor 202b, etc.) However, a Payor 202 may have access to a list of all available Payees. For example, the Payor may have a list of vendors that are associated with said Payor (and/or a list of Payees that are associated with said Core System/Platform), hence having a “vendor database.” The Payee list may be loaded into the Core System/Platform so when the Payor was ready to make a payment, the Payor may search and find the relevant Payee uploaded into the Core System/Platform and could select the relevant Payee for payment transfer to them, for starting negotiations with them, etc.

Accordingly, in module/step 212, Payee List(s) may be uploaded (imported, amended, deleted, and the like). For example, an uploaded Payee list would be entered into the Payor's (202's) specific account in the database (e.g., database 108).

In module/step 216, the Front-End System/Platform 130 may communicate with Payee(s) via emails, text messages, system notifications, etc. In addition, in module/step 216, the Front-End System/Platform 130 may identify the Payor. Also, in module/step 216, the Front-End System/Platform 130 can invite Payee(s) to enroll to use the System/Platform 100 for interactions with Payor (e.g., including but not limited to receiving payments from Payor(s)). More specifically, a user (e.g., the Payor 202) can invite another user (e.g., a Payee) to take part in a Dynamic Negotiation Program (e.g., at least FIGS. 1-8) where the first user can make an offer on their pending invoices, account receivable, account payables, etc.

Accordingly, in at least module/step 216, a communication exchange may be performed between at least a Payor(s) and a Payee(s) to negotiate payment(s) (whereby a Facilitator can intervene at any part/step of the communication exchange). For example, the Front-End System/Platform 130 may allow (1) the Payor to offer advanced payment/payment ahead of the invoice payment due date in exchange for a discount on an outstanding invoice (and/or combined payment of multiple outstanding invoices for a discount, and/or etc.), and/or (2) the Payor to request extended payment terms for a certain offered (e.g., Payor desired) premium, and/or (3) the Payee to (3a) refuse and/or accept payment according to the Payor—Payee contract, and/or (3b) Payee may a counter offer with a different terms (e.g., a different discount, a different (sooner) date of advanced payment, and/or etc.), and/or (3c) Payee may offer the Payor an extended/late payment for a certain (e.g., Payee desired) premium.

In module/step 216, the Payee may be presented with a selection of whether or not the Payee desires to participate in the negotiations via the Core System/Platform. Accordingly, the Payee may be presented with a selection to either accept or decline participation in using the Core System/Platform as a method of payment. In the absence of either party/both parties using the Core System/Platform to negotiate, the Payee would get paid in accordance with whatever contract was in place between the parties. Hence, the Core System/Platform will always default to the loaded contract terms if no negotiations are preformed and/or accepted. The database (e.g., database 108) is updated to reflect Payee election and Payee paid in accordance with the payment terms in Payor—Payee contract. In the absence of Payee electing the Payee preferred method like being paid via ACH or virtual or prepaid card, the stored default method is used, e.g., payment will be defaulted to be made by paper check.

If, in module/step 216, the Payee may select to decline participation in module/step 216, the termination process is executed in module/step 218. The termination process may end the negotiation on the invoice and the invoice is paid in accordance with the contract terms between the parties. After the invoice is paid based on the terms agreed, further use of the Core System/Platform for the “terminated” invoice may cease.

However, if in module/step 216, the Payee may select to accept participation in module/step 216, the Payee Participation Process in module/step 220 is executed.

In module/step 220, in response to the Payee electing to participate in the Vendor Participation Process, as noted the Payee has to elect to use the Core System/Platform to receive payment; if it doesn't the contract will control the mechanics of payment. The Payee provides certain information like Payee name, Payee address, Payee phone number, Payee contact information including phone number(s) and/or email address(es), etc. In addition, the Payee may select it's the Payee's preferred payment method; one form of ACH, paper check, virtual or prepaid card, etc. In the event of an ACH selection as the Payee's preferred payment method, the Payee may also provide bank name, address, bank EIN, routing number(s) Payor bank account number(s), and/or etc.

Module/step 220 provides an output/feedback to the Back-End System 104. This output/feedback may allow for the Payee to respond to the Payor offer by acceptance or rejection or counteroffer, including multi modal payment options, e.g., crypto currency, security instruments, commodities, discounts/premiums depending on payment timing, etc.

The Back-End System/Platform may include a Payables & Receivables System/Module/Platform 124. The Core System/Platform integrates with Payor's accounting system payments functionality. For example, once the backend system is updated, then the Core System/Platform/Back-End may update the User's accounting system. On the Payor side, the Core System/Platform/Back-End may update the Payor accounts payable area of the accounting system to reflect the fact of payment; while on the Payee side, the Core System/Platform/Back-End may update the accounts receivable area of the Payee accounting system. One of many benefits is that this allows for the System/Platform 100 to document in an auditable fashion the Payor's payment obligations regarding amount(s), Purchase Order(s), Work Order(s), invoice number(s), bill of lading number(s), other documents relating to the payment obligation, payment timing/dates, etc.

Also, the Back-End System/Platform may include a Notification system/module 116. The Back-End System/Platform may notify Payor(s) and Payee(s) of payment(s), payment method(s) used and/or selected, payment amount(s), payment date(s), associated PO, WO, Bill of Lading, and other associated documentation through an auditable transaction trail, etc.

In addition, the Back-End System/Platform may include a Session management system/module 118. The Session management system/module 118 may be used to help ensure that Payor and Payee are active on the System/Portal 100 during their specific negotiation phase/period and times out if either or both the Payor and/or Payee fails to timely complete the transaction their specific negotiation phase/period.

For example, the Payor and the Payee may go through as many negotiation interactions as they elect to go through; there is no limit. Each of the parties may offer early payments with a discount on the Payee's invoice, accept payment according to their contract, late payment with a Customer/Payor premium paid, and/or etc.

Furthermore, the Back-End System/Platform may include a Workflow Management System/Module 106. The Core System 102 may define intended Payor workflow processes, e.g., from entry of a payable into the Payor's accounting system through each review, approval, and execution of payment touchpoint within the Payor's organization. The management may be via single or multiple touch points, one or a plurality of reviewers, and one or a plurality of approvers, one or a plurality of payment actions, etc. The Core System 102 may integrate any, some and/or all of the management processes with functionality of the accounting system (e.g., modules 122 and/or 124).

The Back-End System/Platform may include an Accounting package integration system/module 122. The Core System/Platform may be integrated with (1) Payor's accounts payable/accounting system and bank and (2) Payee's accounts receivable function/accounting system and bank. Updating a User's accounting systems includes but is not limited to, tracking and noting status of at least (1) accounts payable (AP), (2) accounts receivable (AR), (3) invoice creation and issuance, (4) bad debt management, and (5) trade finance activities.

In (and/or in conjunction with) the Back-End System 104, data from at least System/Platform 199 (like transaction data including but not limited to associated PO, WO, Bill of Lading, and other associated documentation, etc.) is prepared for updates to the database 108.

The Back-End System/Platform may include a database(s) 108. The System/Platform database(s) 108 may be updated to reflect any and all new data, revised data, etc. like Payor and/or Payee transaction status, e.g., enrollment, payment/receivable (bank) information, Payor and Payee specific information, e.g., change of address(es), as well as transaction data including but not limited to, PO, WO, Bill of Lading, and other associated documentation, etc. method(s) of payment(s), date(s), amount(s) and related information included in database(s), and/or etc. It should be noted that the database 108 may also be located in any part of the system (e.g., in the Back-End System/Platform, and/or in the Core System/Platform 102, and/or off-site in regard to System/Platform 100, and/or etc.).

The Core System/Platform 102 may include at least Component/Step 210. While Module/Step 102 represents the system's core platform, the Module/Step 102 may include smaller component communication systems, protocols or hubs which assist in the flow of data and communications between the frontend users and the backend system. Accordingly, Component/Step 210 may include various channels available for communication between the frontend and the backend system. Accordingly, the Component/Step 210 may be a component and/or a part of Module/Step 102.

Component/Step 210 includes for example, a communication module having numerous Communication method options. For example, updated Backend Systems information may be forwarded via computer network (306), internet, digital channel (308), voice call (310), secure email (312) and the like to Payor Portal (132) to provide Payor information and communication tools about Payee's election to use, or not to use, the Core System/Platform, to communicated an election to accept a discount, get paid in the ordinary course in accordance with the Payor—Payee contract, of accept late payment with a premium, to establish the method of payment, etc.

Component/Step 210 includes for example, an Integrations module 304. The Core System/Platform may be integrated with for example, Payor accounting systems and general ledger systems to facilitate communication between Payor—Payee invoice negotiation and establish final disposition of the payment transaction.

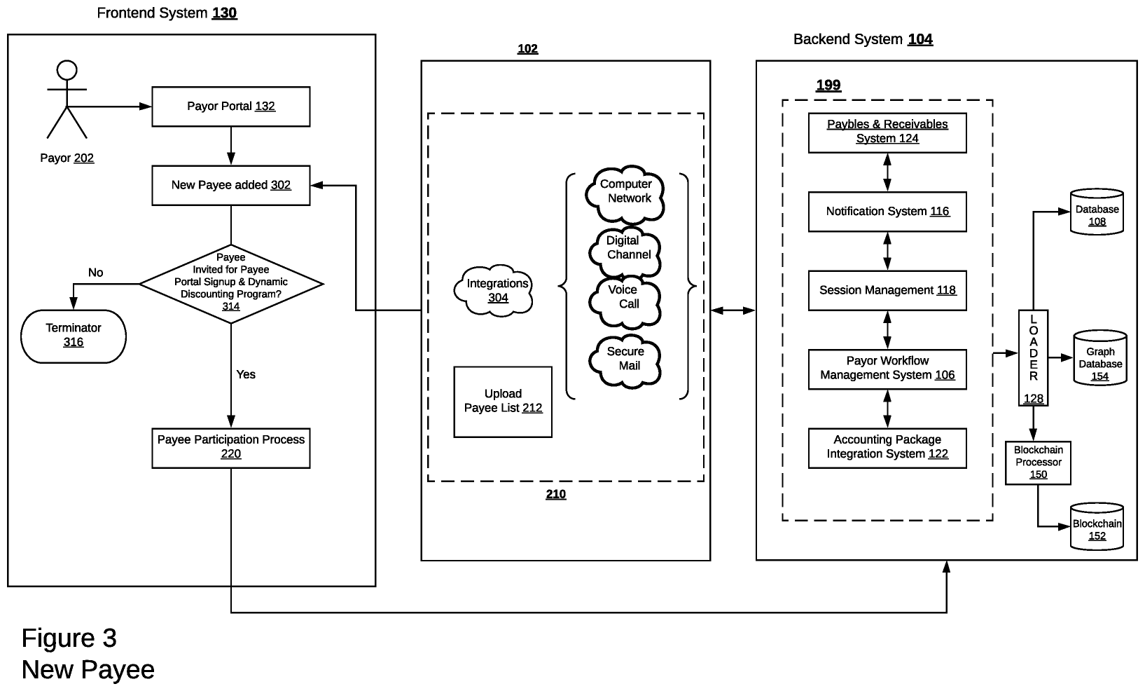

FIG. 3 is an example of a functional block diagram/flow chart illustrating a New Payee enrollment system and method according to at least one or more embodiments described herein. For example, FIG. 3 illustrates how a user (e.g., a Payee, a Payor, etc.) may enroll in the system.

After an authentication process, a first user, for example the Payor, enters/accesses their portal, e.g., the Payor portal 132, in order to access/use to be able to use the System/Platform (e.g., System/Platform 100).

In module/step 302, the first user (e.g., the Payor) enters/selects a Payee(s) as a payee(s) (select other user(s) as possible entities to conduct a transaction with like a Payee). In addition, in module/step 302 Where is step 302?, the Payor may also provide information like, but not limited to, Payee(s) name(s), EIN number(s), physical address(es), email address(es), contact name(s), contact phone number(s), and any remittance data associated with a payment.

In module/step 314, the System/Platform 102 transmits a notification (via an automated and/or non-automated process, and/or an email (e.g., 312), and/or a text message, and/or a phone call (e.g., 310), and/or a voicemail, and/or a notification via a digital channel (e.g., 308), and/or a notification via a computer network (e.g., 306), and/or a etc.) to notify a potential user, e.g., a Payee, of an enrollment invitation via the System/Platform 102. The Payee portal can permit the Payee to enroll as a user of the Core System/Platform. Accordingly, the Payee provides authentication information, e.g., security requirements for Payee to use the Core System/Platform, contact details, email details, physical address details, bank details, and payment modality choice, e.g., ACH, paper or other check, etc.

If, in module/step 314, the Payee makes a selection to not enroll in the enrollment of the discount program, the termination process is executed in module/step 316. For example, the termination process may end further negotiation of an invoice. The fact of termination is noted, the backend systems are updated to reflect that no further action will be taken on the Core System/Platform regarding that invoice, and the invoice will be paid according to the terms the parties previously negotiated.

It should be noted that the feature(s) of 216 and 314 may be used interchangeably, in part or in whole. Similarly, it should also be noted that the feature(s) of 218 and 316 may be used interchangeably, in part or in whole.

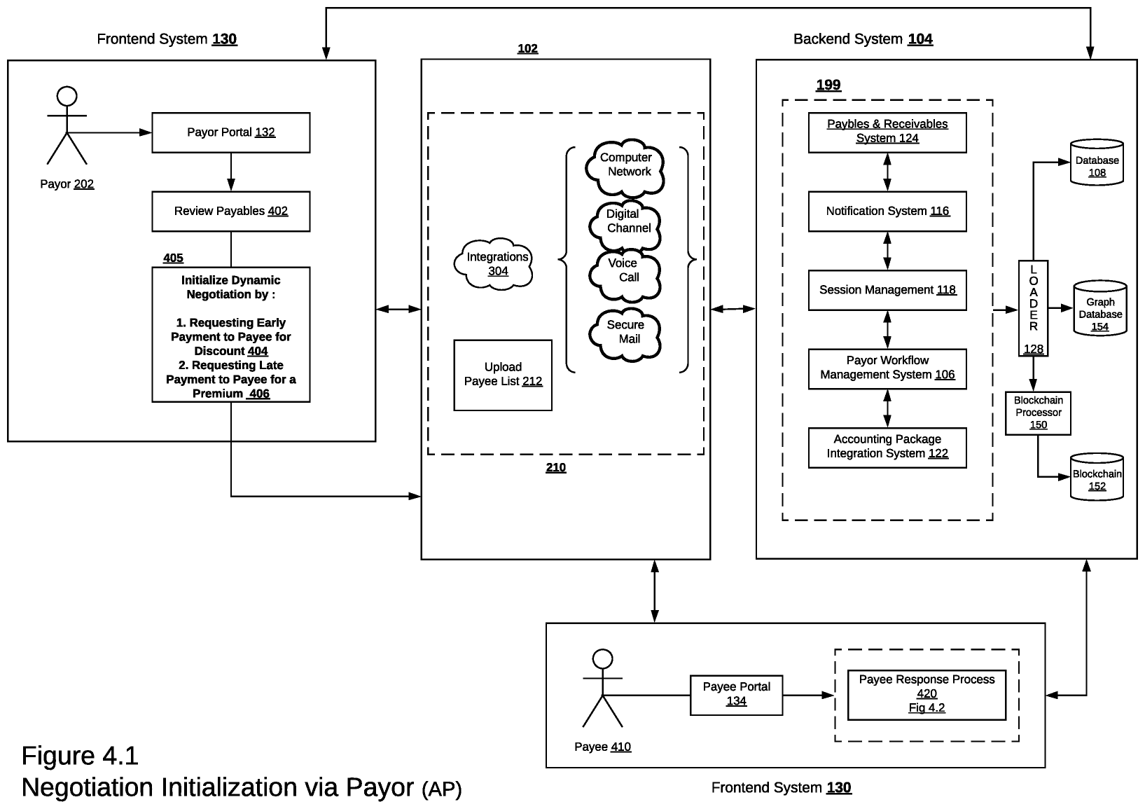

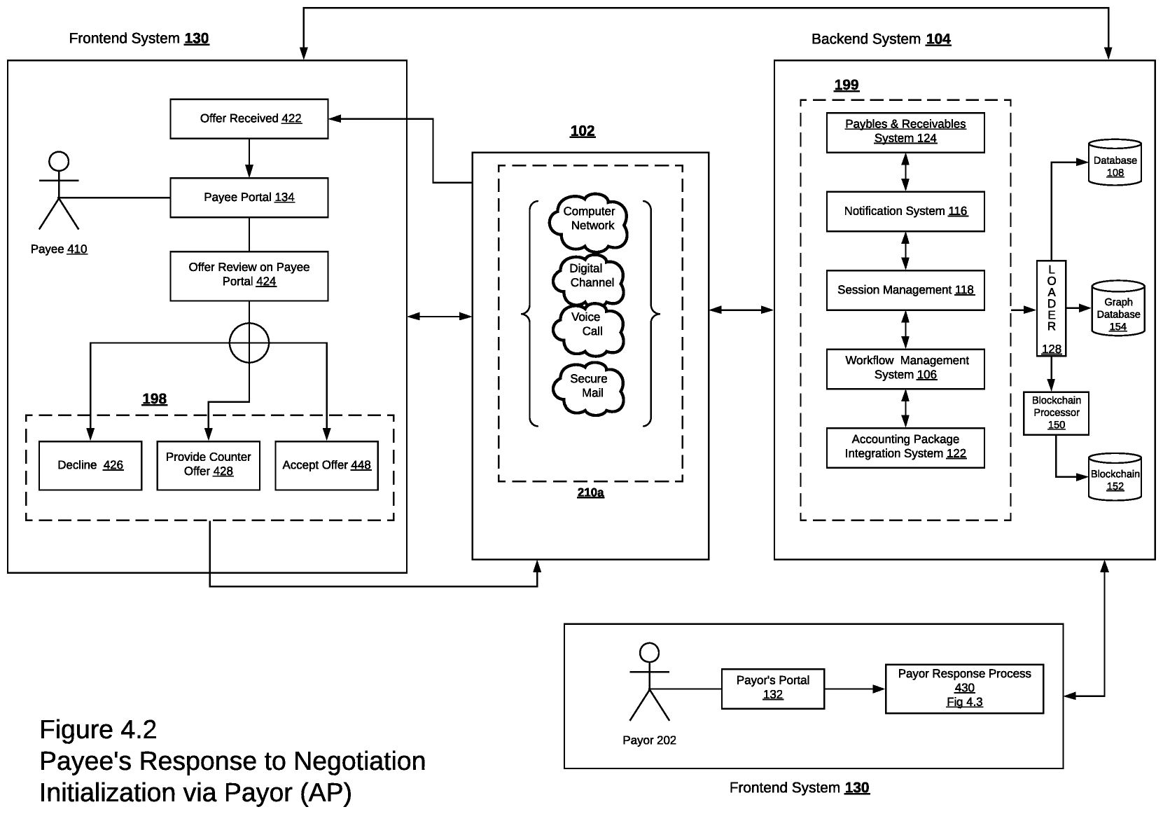

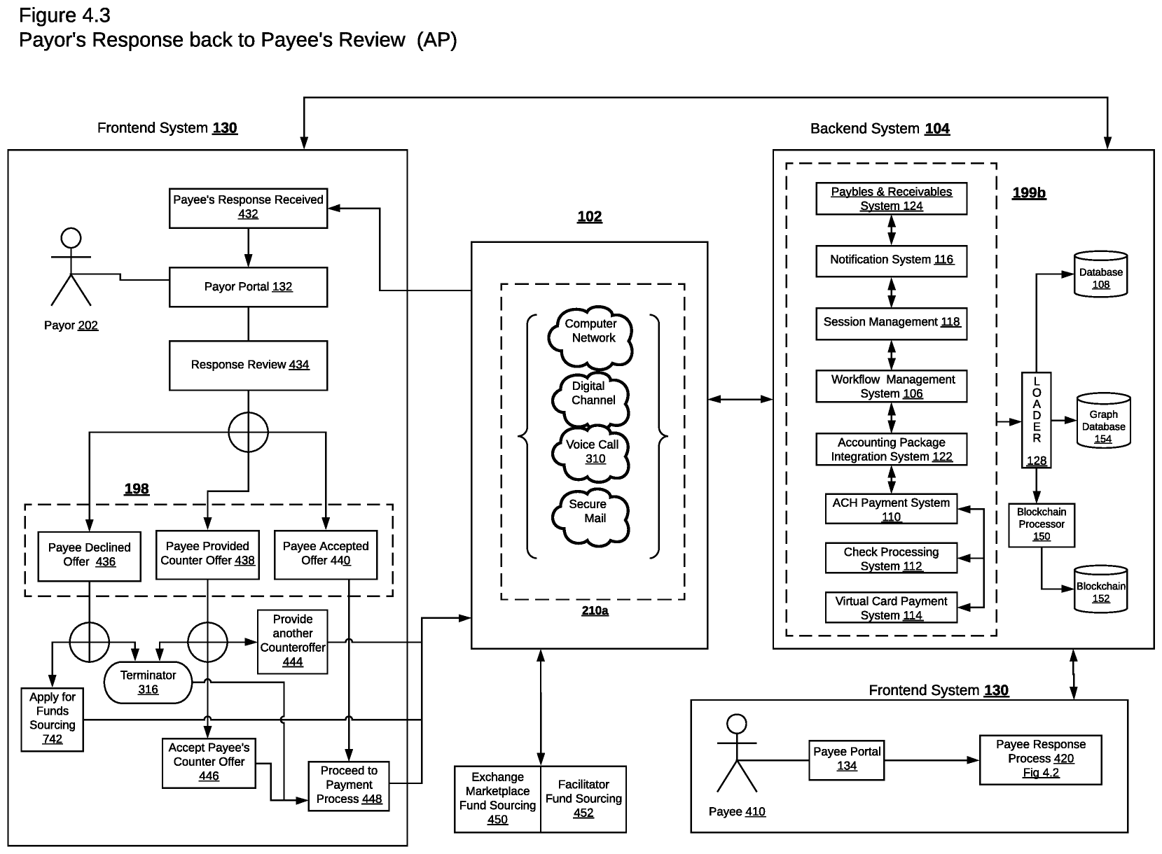

FIGS. 4.1, 4.2 and 4.3 illustrate an example of a Dynamic Negotiation System/Method (e.g., 100) between at least two parties. While FIGS. 4.1, 4.2 and 4.3 illustrate one possible example, each part or multiple parts of FIGS. 4.1, 4.2 and 4.3 may be used interchangeably with other disclosed Figure(s)/embodiment(s).

FIG. 4.1 is an example of a functional block diagram/flow chart illustrating a Negotiation Initialization via a Payor (AP) method and system according to at least one or more embodiments described herein. For example, FIG. 4.1 illustrates how a user (e.g., a Payor, etc.) may initiate a negotiation with another user.

According to at least one or more embodiments, a user for example a Payor 202 (and/or multiple (types of) Payors) may access the Core System/Platform 102. For example, a Payor 202 (and/or a first (type of) Payor e.g., a (Payor) Reviewer (type)) that may access the Front-End System Platform 130 in order to perform an authentication process. The Payor (and/or, for example, an individual employee/representative of the Payor) 202 may authenticate his/her authority to enter into the Payor Portal 132 through an authentication process (e.g., a two-factor authentication process).

In addition, it should be noted that there may be a second (type of) Payor, e.g., an (Payor) Approver (type), that may access the Front-End System Platform 130 in order to perform the approval process, e.g., step(s)/module(s) 404 and/or 406; instead of the same Payor 202. The first or the second Payor and/or, for example, an individual employee/representative of the Payor 202 may authenticate his/her authority to enter into the Payor Portal 132 through authentication (e.g., a two-factor authentication process).

After an authentication process, the Payor 202 enters/accesses the Payor portal 132 in order to access/use to be able to use the System/Platform (e.g., System/Platform 100).

In module/step 402, the Payor 202 (and or the second Payor) may review the Payee's invoice and/or the Accounts Payable (AP) (and/or Account Receivables (AR), or the like). Based on the Payor's review (of e.g., the Payee's invoice and/or the Accounts Payable), the Payor may 1) label an item as a first type, e.g., label the invoice as “complete” whereby the invoice is determined to be payable (a) in accordance with its terms or (b) subject to negotiation on a different amount and time of payment, 2) label the item as a second type, e.g., label the invoice as “incomplete” whereby the invoice is determined to be not payable until it is complete, e.g., it lacks an amount payable, and/or 3) label an item as a third type, e.g., label the invoice as “partially complete” or “partially incomplete,” whereby the invoice is determined to be payable if all the parties agree to use the Core System/Platform to negotiate payment terms, e.g., amount and timing of payment. For example, when the invoice is marked as “complete” the Payor 202, the invoice may be sent to the second Payor approver for payment and/or to enter into Core System/Platform based negotiations for an early pay discount 404 and/or a late pay premium 406, and/or etc. (and/or the like and/or similar other options as discussed in this disclosure) or the Payor 202 may do this functionally as illustrated in the Figure themselves. It should be noted that “Complete” may include payment amount, payment timing, and related (i) purchase order, (ii) work order, and/or (iii) bill of lading, one or more of the foregoing as relevant When incomplete the invoice is returned to the Payee for additional information linking the invoice to a purchase order, work order and/or a bill of lading.

In module/step 405, a user like the Payor 202 (and/or the (second) Payor approver) may send an offer(s) to another user like the Payee 410, the offer may be to pay early for a discounted payment amount 404 and/or the offer may be to pay late in exchange for a premium payment 406, and/or etc. (and/or the like and/or similar other options as discussed in this disclosure). It should be noted that the offer would be based on a current outstanding invoice(s) that is due to the other party and the first party desire to negotiate payment terms different than what was originally agreed upon (e.g., in a contract or the original invoice).

While in FIG. 4.1, it is illustrated that the Payor initiated a negotiation by requesting/offering the initial request (e.g., early pay for a discounted payment amount, late pay for a premium, etc.), according to one or more embodiments, anyone may initiate the request (anyone may make the initial offer). For example, any Payor may initiate the initial offer (and go through the process with a Payee). Alternately, any Payee may initiate the initial offer (and go through the process with a Payee). In addition, any third party (e.g., someone authorized on behalf of the Core System/Platform, a third-party (e.g., an outside financial institution, a bank, an investor, etc.) may initiate the initial offer (and go through the process with any Payee and/or Payor). Also, the Facilitator (and/or someone authorized on behalf of the Facilitator) may initiate the initial offer (and go through the process with any Payee and/or Payor). Regardless of the entity making the initial offer (except maybe for the Core System/Platform institution), the Core System/Platform institution would collect a fee for the transaction (e.g., a percentage of the premium or discount, a flat fee, etc.) In addition, if the entity making the initial offer is the Core System/Platform institution, the Core System/Platform institution may have their own incentives in making the offer like obtaining the premium by allowing late payment (while paying the Payee on time).

In addition, the Core System/Platform may operate with numerous options in addition to the pay early for a discount option and the pay later for a premium option. For example, there is another payment option in accordance with the terms of the invoice, e.g., the agreed contract terms between the parties. In addition, there may be a trade finance option, where the (1) Payor borrows funds from a third party to make payment, whether discounted, at terms, or at a premium or (2) Payee sells the account receivable to a third party who in turns looks to the Payor for payment.

Via a Front-End (e.g., a second Front-End) system 130, Payee 410 accesses the Core System/Platform 102 via the Payee Portal 134. Once the Payee 410 is authenticated, the Payee may access the Core System/Platform to accept an offer, reject an offer, make a counter offer etc. in response to a customer making such an offer in module/step 420. One example of Module/Step 420 is illustrated in at least FIG. 4.2.

According to this and other embodiments, it should be noted that the Facilitator of the System may receive the offer from the sender before it is send (routed) to the recipient so that the Facilitator may decide to accept the offer, decline the offer, make a counter offer, send it to the Marketplace, approve to send the offer to the recipient, etc. giving the Facilitator the first right in each and every transaction, in each and every negotiation, etc. Aspects of the Facilitator intervention/control will be discussed in more detail in the disclosure and are not limited to only this paragraph.

FIG. 4.2 is an example of a functional block diagram/flow chart illustrating a Payee Response to Negotiation Initialization via Payor AP method and system according to at least one or more embodiments described herein.

In module/step 422, the Payee 410 may receive offer(s) (e.g., via 306, 308, 310, and/or 312) to be paid early in exchange for a payment discount and/or late for a payment premium (and/or the like and/or similar other options as discussed in this disclosure). While FIG. 4.2 discloses that these offer(s) may be sent via the Payor as illustrated in at least FIG. 4.1, it should be noted that any party (Facilitator, third party investor, etc.) may send the offer to the Payee.

The Payee 410 and/or, for example, an individual employee/representative of Payee 410 may authenticate his/her authority to enter into the Payee Portal 134 through authentication (e.g., a two-factor authentication process).

In module/step 424, the Payee 410 may review the Payor's offer(s) (and/or any other offers from anyone from the system) and respond accordingly, for example, to either (1) accept early payment with a discount on the face amount of the Payee's invoice or (2) accept a late payment from Payor with a premium over the face amount of the invoice. It should be noted that the review choices may not be limited to the two disclosed options, and instead the Payee 410 may review any and all combinations of choices.

Based on the Payee 410's review and/or decision made, the Payee 410 may for example a) decline the offered discount 426 and await payment in accordance with the Vendor contract, b) make a counteroffer 428 to the Payor (e.g., offer a different discount and/or offer a late payment with a premium and/or etc.) and/or c) Payee 410 accepts Payor offer 448 (e.g., Payor discount offer and payment terms or Payor premium offer and payment terms).

In Front-End (a second Front-End) system 130, the authentication of a Payor (and/or Payor (Reviewer)) may be provided. The Payor 202 and/or, for example, an individual employee/representative of the Payor may authenticate his/her authority to enter into the Payor Portal 132 through authentication (e.g., a two-factor authentication process).

After authentication for access to the Payor Portal 132, the Payor response process is invoked, and the Payor responds to Payee via the Core System/Portal. One example of Module/Step 430 is illustrated in at least FIG. 4.3.

While in FIG. 4.2, it is illustrated that the Payee is responding the Payor's initial offer, the opposite may also be true where the Payee made the initial offer and the Payor is making the response back.

According to this and other embodiments, it should be noted that the Facilitator of the System (e.g., 100) may receive the counteroffer from the sender before it is send (routed) to the recipient so that the Facilitator may decide to accept the counteroffer, decline the counteroffer, make a counter offer, send it to the Marketplace, approve to send the counteroffer to the recipient, etc. giving the Facilitator the first right in each and every transaction, in each and every negotiation, etc. Aspects of the Facilitator intervention/control will be discussed in more detail in the disclosure and are not limited to only this paragraph.

FIG. 4.3 is an example of a functional block diagram/flow chart illustrating a Payor Response to Payee's Review AP method and system according to at least one or more embodiments described herein.

In module/step 432, the Core System/Platform sends (via the communication channels 306, 308, 310, 312, etc.) the Payee's offer (and/or any and/or all offers from any user on the system having offers to send to the Payor) to the Payor 202 in Module/Step 432. Once the Payor 202 has logged into the Front-End system 132 and passed the authentication process, the Payor 202 receives and reviews the Payee 410's response in Module/Step 434.

For example, the Payee's response may be that 436) the Payee has declined Payor's offer (e.g., (a) discount offer or (b) premium offer) thereby requiring payment to be made in accordance with original contract terms (e.g., original contract terms stored in system 100) or 438) the Payee has made a counteroffer to Payor (different discount, different premium, different date of payment, late pay with premium, different terms, etc.), or 440) the Payee has accepted the Payor's offer, or etc.

If the Payee's response was to decline the Payor's offer 436 (e.g., early pay or late pay, etc.), then the Payor may make a selection on how to proceed. For example, the Payor may select to proceed by 742) move account payable (e.g., the amount due according to the original contact in place) to the payables exchange marketplace 450 and/or the Facilitator Fund sourcing 452 for possible funds sourcing from the facilitator and/or the exchange marketplace (e.g., a third party fund sourcing) or the Payor may select to proceed by 316) terminate further action on invoice transaction and proceed to the payment processing in 448. However, according to this and/or any other embodiments, the Core System may also allow the Payor to make another offer (e.g., a counteroffer) even though the Payee declined. Facilitator and or exchange marketplace (if forwarded from the facilitator) may accept terms sent by the payee or payor at any point during the negotiation process. (For AP—Extended Pay terms for Premium; AR—expedited pay terms for discount.)

It should be noted that the exchange marketplace may be an approved group (e.g., approved by the Facilitator) of potential funders, investors, etc. and including but not limited to financial institutions, banks, insurance companies, businesses, funds, and/or individuals, etc. to participate in the funding of transactions between any users of the core System/Platform.

In Module/Step 742, according to this embodiment and/or any other embodiment(s), a user (e.g., a Payor) may select to apply/request for the amount they owe to another user (e.g., a Payee) to be offered (auctioned, etc.) for fund sourcing. Accordingly, when a user makes a request in 742, Module/Step 450 and/or Module/Step 452 is initiated by the user. However, the Facilitator may, at any time (even if negotiations have not begun), initiate Module/Step 450 and/or Module/Step 452.

In Module/Step 452, according to this embodiment and/or any other embodiment(s), the Facilitator may accept the terms sent by any user (e.g., the Payee and/or the Payor) when the user selects 742. The Facilitator may also intervene in any point of the negotiations and accept any user's offer. However, the Facilitator may also, at any time, forward the offer, the Accounts Receivables, the Accounts Payable, etc. to the Exchange Marketplace 450 for possible fund sourcing.

Accordingly, in Module/Step 452, the Facilitator may fund the user directly (e.g., via Facilitator funds) and/or indirectly (e.g., via third party funds).

In response to the user requesting fund sourcing in 742, the Facilitator (in 452) may determine not to provide fund sourcing via the Facilitator so the Facilitator forwards the user request/offer to the Exchange Marketplace for fund sourcing.

In response to the user requesting fund sourcing in 742, the Facilitator may also automate the system to go directly from 742 to 450. The automation may be determined based on available amount of Facilitator funds, the amount of fund sourcing requested by the user, etc.

The Exchange Marketplace is comprised of Facilitator pre-approved user, like Facilitator based third parties pre-approved by the Facilitator to take advantage of funding source offers. Exchange marketplace (if forwarded from the facilitator) may accept terms sent by the user (e.g., the payee and/or payor) at any point during the negotiation process.

According to this embodiment and/or any other embodiment(s), Fund Sourcing may include, but not limited to: financing, investing, factoring, forfaiting, over drafting, loans (including working capital loans), crediting, payment-in-advance, etc.

In Module/Step 316, the Payor may terminate further action on the invoice/negotiation transaction. In other words, if the termination is selected, the negotiation phase is completed, and the Core System/Platform is informed of such a completion (so that that the Core System/Platform can inform any or all users of the completion of negotiations). Once the negotiation is terminated by a Terminator (e.g., 316), the transaction completes with agreed upon original terms.

If the Payee's response was to provide a counteroffer to the Payor's offer 438, then the Payor may make a selection on how to proceed. For example, the Payor may select to proceed by 444) the Payor providing (another counteroffer) to the Payee, or 446) the Payor accepting the Payee's offer, or 316) terminate further action on invoice transaction.

If the Payee's response (selection) was to accept the Payor's offer 440, then the Payor may 448) proceed directly to payment processing in accordance with the payment type selected and/or negotiated. If the any terms were not negotiated, the defaulted contract terns will be defaulted and/or the Core System/Platform's will be defaulted. For example, if the original contract had i) an amount due and ii) a due date along with iii) a currency type and it was negotiated to have a later due date with a higher amount due, then the Core System may automatically apply the original currency type and/or apply the Core System's may apply the currency transmission type (ACH, etc.) as nothing was indicated in the original contract nor the negotiations.

According to this and other embodiments, it should be noted that the Facilitator of the System may receive the counteroffer from the sender before it is send (routed) to the recipient so that the Facilitator may decide to accept the counteroffer, decline the counteroffer, make a counter offer, send it to the Marketplace, approve to send the counteroffer to the recipient, etc. giving the Facilitator the first right in each and every transaction, in each and every negotiation, etc. Aspects of the Facilitator intervention/control will be discussed in more detail in the disclosure and are not limited to only this paragraph.

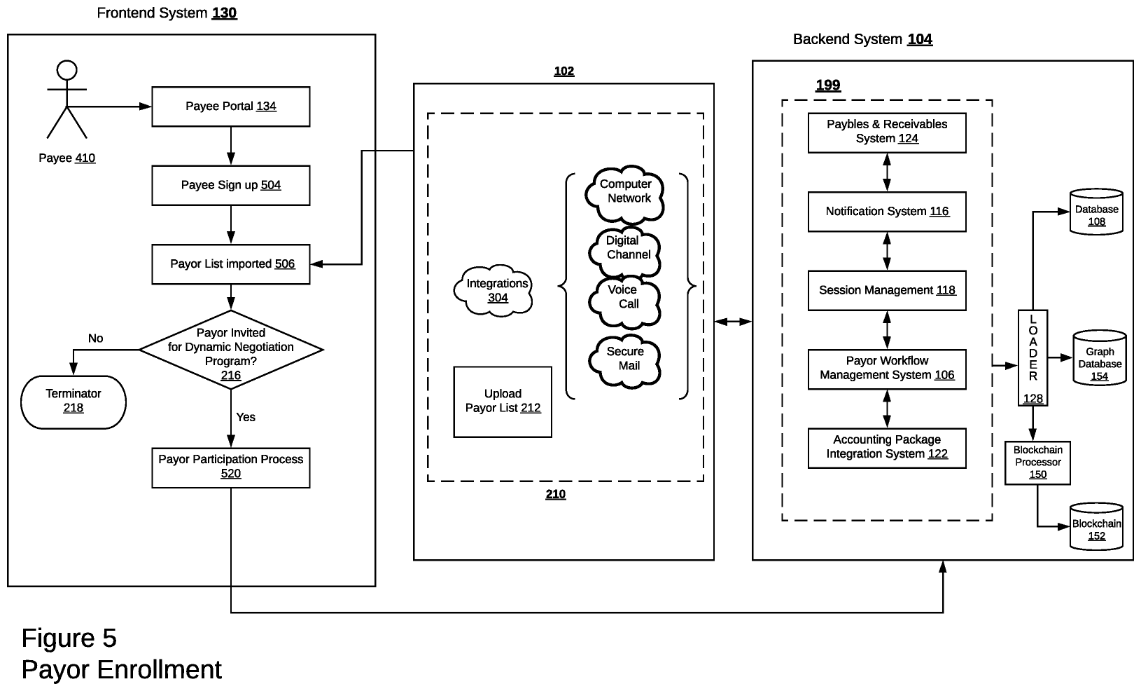

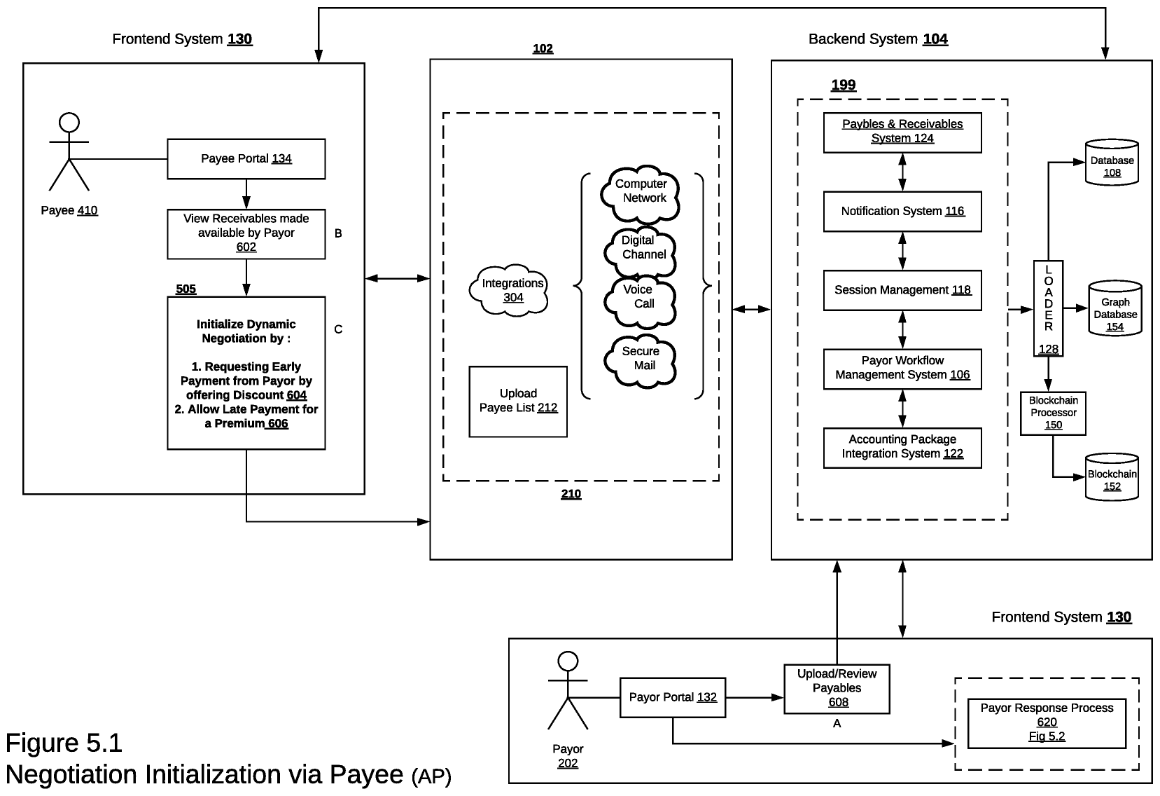

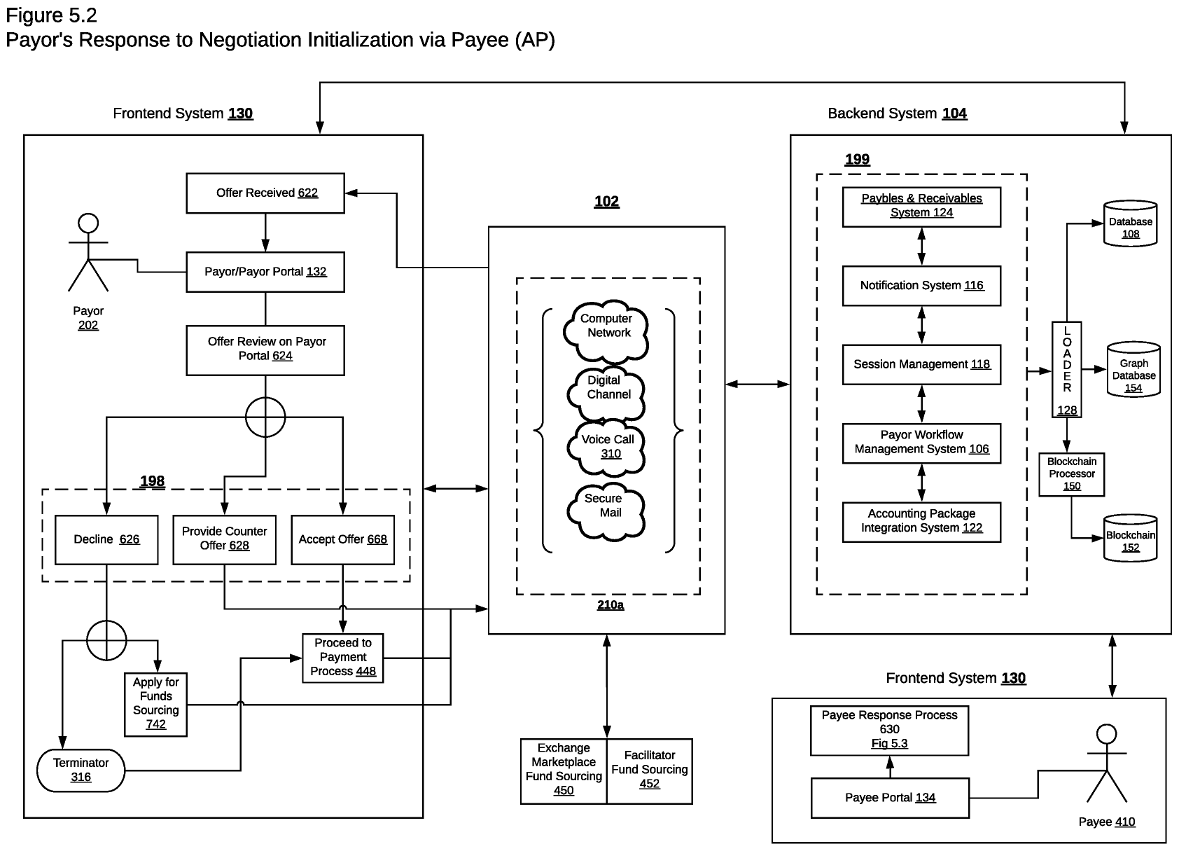

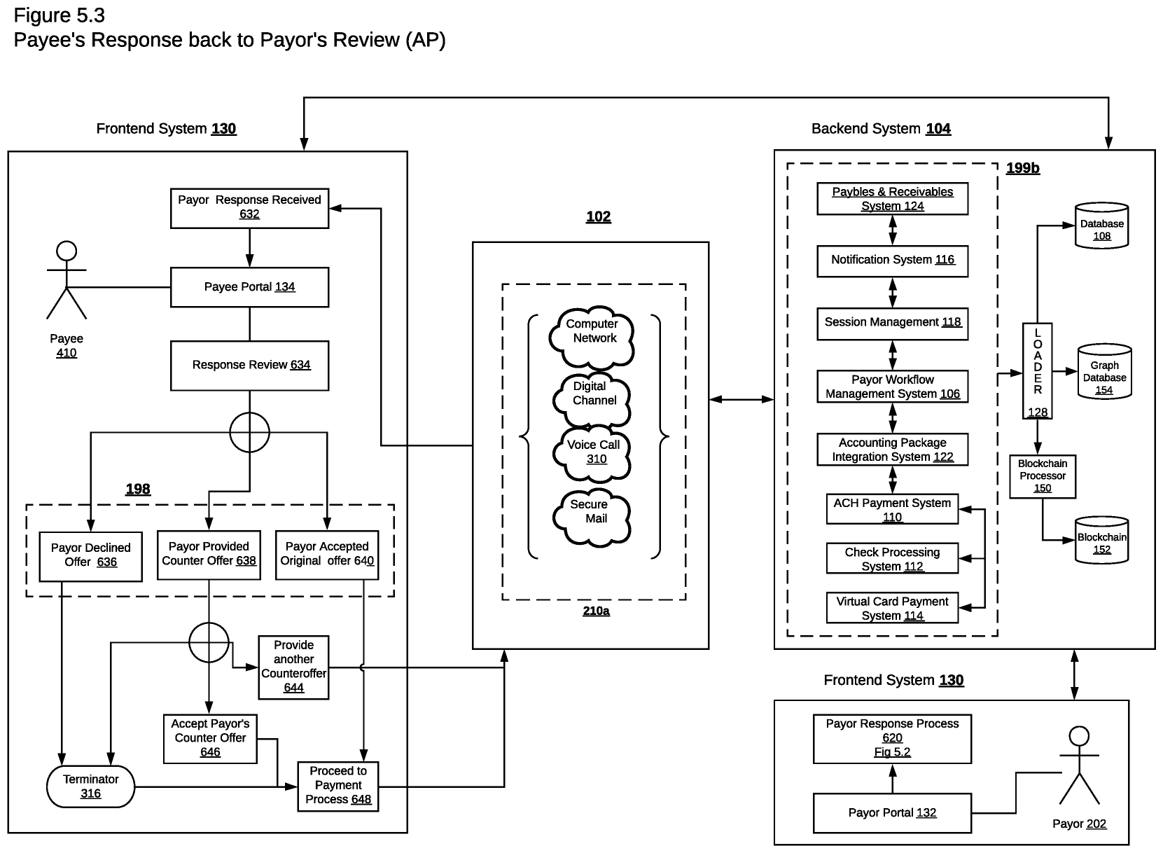

FIG. 5 is an example of a functional block diagram/flow chart illustrating an Enrollment method and system for a Payor according to at least one or more embodiments described herein. However, it should be noted that while this example illustrates the enrollment of a Payor, it is not limited to an example enrollment of a Payor but may also be applied to other enrollees like a Payee, a third-party investor, etc.

According to one or more embodiments, a user (e.g., Payee 410) accesses their portal (e.g., the Payee Portal 134) via a URL, an app, etc. Accordingly, the user (e.g., Payee 410) then preforms a user sign up with the system in 504.

Once the user is signed up, they may create, upload, etc. their additional data like a list of Payors (and associated Payor information), a list of Payees (and associated Payee information), a list of (preferred, already used, etc.) third-party investors, etc. in 506. In addition, the Core System/Platform 102 may allow for a user to import some or all additional data like the mentioned lists, etc. via the Core System/Platform 102 (e.g., databases 108, 154, 150, 152, etc.).

Once the data is imported/created in 506, the user (e.g., Payee 410) can invite another user (e.g., a Payor) to enroll and/or connect with them in the system in 216. For example, the user (e.g., Payee 410) can invite another user (e.g., a Payor) to work with them in the Dynamic Negotiation Program of negotiating to pay early/pay late.

If the invited user (e.g., a Payor) declines the invitation (“No”), then the process is terminated via 218. It should be noted that Terminator 218 may preform similarly as Terminator 316.

If the invited user (e.g., a Payor) accepts the invitation (“Yes”), then the Participation Process begins (e.g., Figures, 5.1, 5.2, 5.3, etc.)

FIGS. 5.1, 5.2 and 5.3 illustrate an example of a Dynamic Negotiation System/Method (e.g., 100) between at least two parties. While FIGS. 5.1, 5.2 and 5.3 illustrate one possible example, each part or multiple parts of FIGS. 5.1, 5.2 and 5.3 may be used interchangeably with other disclosed Figure(s)/embodiment(s).

FIG. 5.1 is an example of a functional block diagram/flow chart illustrating a Negotiation Initialization Accounts Payable (AP) via a Payee method and system according to at least one or more embodiments described herein. For example, FIG. 5.1 illustrates how a user (e.g., a Payee, etc.) may initiate a negotiation with another user.

As discussed, any entity that is authorized access to the Core System/Platform may make the initial offering. Accordingly, as now illustrated in at least FIG. 5.1, the Payee may initiate the negotiations for their Account Payables.

Similar to the Payor's review in 402, in module/step 602, the Payee may review the invoice (and/or invoice details like invoice payment status, progress in Payor/Payee payments queue, etc.) and/or review account receivables made available by the Payor. Based on the Payee's review of the invoice, the Payee may 1) label the invoice as “complete” whereby the invoice is determined to be payable (a) in accordance with its terms or (b) subject to negotiation on a different amount and time of payment, 2) label the invoice as “incomplete” whereby the invoice is determined to be not payable until it is complete, e.g., it lacks an amount payable, and/or 3) label the invoice as partially complete or partially incomplete, whereby the invoice is determined to be payable if all the parties agree to use the Core System/Platform to negotiate payment terms, i.e., amount and timing of payment.

Similar to Module/Step 405 which includes Module/Step 404 and/or 406, in Module/Step 605 which includes Module/Step 604 and/or 606, the Payee may request the Payor early pay for a discounted payment amount 604 and/or request late payment in exchange for a premium payment 606, and/or etc. (and/or the like and/or similar other options as discussed in this disclosure).

Via a Front-End (e.g., a second Front-End) system 130, Payor 202 accesses the Core System/Platform 102 via the Payor Portal 132. Once the Payor 202 is authenticated, the Payor may access the Core System/Platform to accept an offer, reject an offer, make a counter offer etc. in response to a Payee making such an offer in module/step 620. One example of Module/Step 620 is illustrated in at least FIG. 5.2.

In addition, via the Front-End (e.g., a second Front-End) system 130 and in for example, Module/Step 608, the Payor 202 may upload invoice(s)/payable(s); review invoice(s)/payable(s), revise invoice(s)/payable(s), pay invoice(s)/payable(s) following re-invocation of Payor response process, etc.

According to this and other embodiments, it should be noted that the Facilitator of the System may receive the offer from the sender before it is send (routed) to the recipient so that the Facilitator may decide to accept the offer, decline the offer, make a counter offer, send it to the Marketplace, approve to send the offer to the recipient, etc. giving the Facilitator the first right in each and every transaction, in each and every negotiation, etc. Aspects of the Facilitator intervention/control will be discussed in more detail in the disclosure and are not limited to only this paragraph.

FIG. 5.2 is an example of a functional block diagram/flow chart illustrating a Payor Response to Negotiation Initialization via Payee AP method and system according to at least one or more embodiments described herein.

In module/step 622, the Payor 202 may receive offer(s) (e.g., via 306, 308, 310, and/or 312) to be paid early in exchange for a payment discount and/or late for a payment premium (and/or the like and/or similar other options as discussed in this disclosure) from for example Payee 410.

The Payor 202 and/or, for example, an individual employee/representative of the Payor 202 may authenticate his/her authority to enter into the Payor Portal 132 through authentication (e.g., a two-factor authentication process).

Similar to Module/Step 424, in Module/Step 624, the Payor 202 may review offer(s) (e.g., the Payee's offer(s), and/or any offer(s) from users on the system) and respond accordingly, for example, to either (1) accept early payment with a discount on the face amount of the Payee's invoice or (2) accept a delayed (late) payment with a premium over the face amount of the invoice. It should be noted that the review choices may not be limited to the two disclosed options, and instead the Payor 202 may review any and all combinations of choices.

Based on the Payor's review and/or decision made, the Payor may for example a) decline the offered discount 626 and make payment in accordance with the Payor/Payee contract, b) make a counteroffer 628 to the Payee (e.g., offer a different discount and/or offer a late payment with a premium and/or etc.) and/or c) Payor accepts Payee offer 668 (e.g., Payee discount offer and payment terms or Payee premium offer and payment terms).

If the Payor's response (selection) was to accept the Payee's offer and/or to Terminate, then the Payor may 448) proceed directly to payment processing in accordance with the payment type selected and/or negotiated. If the any terms were not negotiated, the defaulted contract terns will be defaulted and/or the Core System/Platform's will be defaulted. For example, if the original contract had i) an amount due and ii) a due date along with iii) a currency type and it was negotiated to have a later due date with a higher amount due, then the Core System may automatically apply the original currency type and/or apply the Core System's may apply the currency transmission type (ACH, etc.) as nothing was indicated in the original contract nor the negotiations.

In Front-End (a second Front-End) system 130, the authentication of the Payee may be provided. The Payee and/or, for example, an individual employee/representative of the Payee may authenticate his/her authority to enter into the Payee Portal 134 through authentication (e.g., a two-factor authentication process).

After authentication for access to the Payee Portal 134, the Payee response process is invoked, and the Payee responds to Payor via the Core System/Portal 102. One example of Module/Step 630 is illustrated in at least FIG. 5.3.

According to this and other embodiments, it should be noted that the Facilitator of the System may receive the counteroffer from the sender before it is send (routed) to the recipient so that the Facilitator may decide to accept the counteroffer, decline the counteroffer, make a counter offer, send it to the Marketplace, approve to send the offer to the recipient, etc. giving the Facilitator the first right in each and every transaction, in each and every negotiation, etc. Aspects of the Facilitator intervention/control will be discussed in more detail in the disclosure and are not limited to only this paragraph.

FIG. 5.3 is an example of a functional block diagram/flow chart illustrating a Payee's Response back to Payor's Review AP method and system according to at least one or more embodiments described herein.

In module/step 632, the Core System/Platform sends (via the communication channels 306, 308, 310, 312, etc.) the Payor's offer to the Payee 410. Once the Payee 410 has logged into the Front-End system 130 and passed the authentication process, the Payee 410 receives and reviews the Payor's response in Module/Step 634.

For example, the Payor's response may be that 636) the Payor has declined Payee's (a) discount offer or (b) premium offer thereby requiring payment to be made in accordance with original contract terms or 638) the Payor has made a counteroffer to Payee (different discount, different premium, different date of payment, late pay with premium, terms, etc.), or 640) the Payor has accepted the Payee's offer, or etc.

If the Payor's response was to decline the Payee's offer 636, then the negotiations is terminated via Module/Step 316 (and hence terminates any further action on invoice transaction/negotiations). However, according to this and/or any other embodiments, the Core System may also allow the Payee to make another offer (e.g., a counteroffer) even though the Payor declined.

It should be noted that, similar Modules/Steps may function the same and hence will not be repeated (similar numbering, similar labeling, similar placement in Figures, etc.). For example, Module/Step 446 may function the same as Module/Step 646 except that the roles of Payor and Payee are switched. The same is valid for 444 and 644, 448 and 648, etc.

According to this and other embodiments, it should be noted that the Facilitator of the System may receive the counteroffer from the sender before it is send (routed) to the recipient so that the Facilitator may decide to accept the counteroffer, decline the counteroffer, make a counter offer, send it to the Marketplace, approve to send the offer to the recipient, etc. giving the Facilitator the first right in each and every transaction, in each and every negotiation, etc. Aspects of the Facilitator intervention/control will be discussed in more detail in the disclosure and are not limited to only this paragraph.

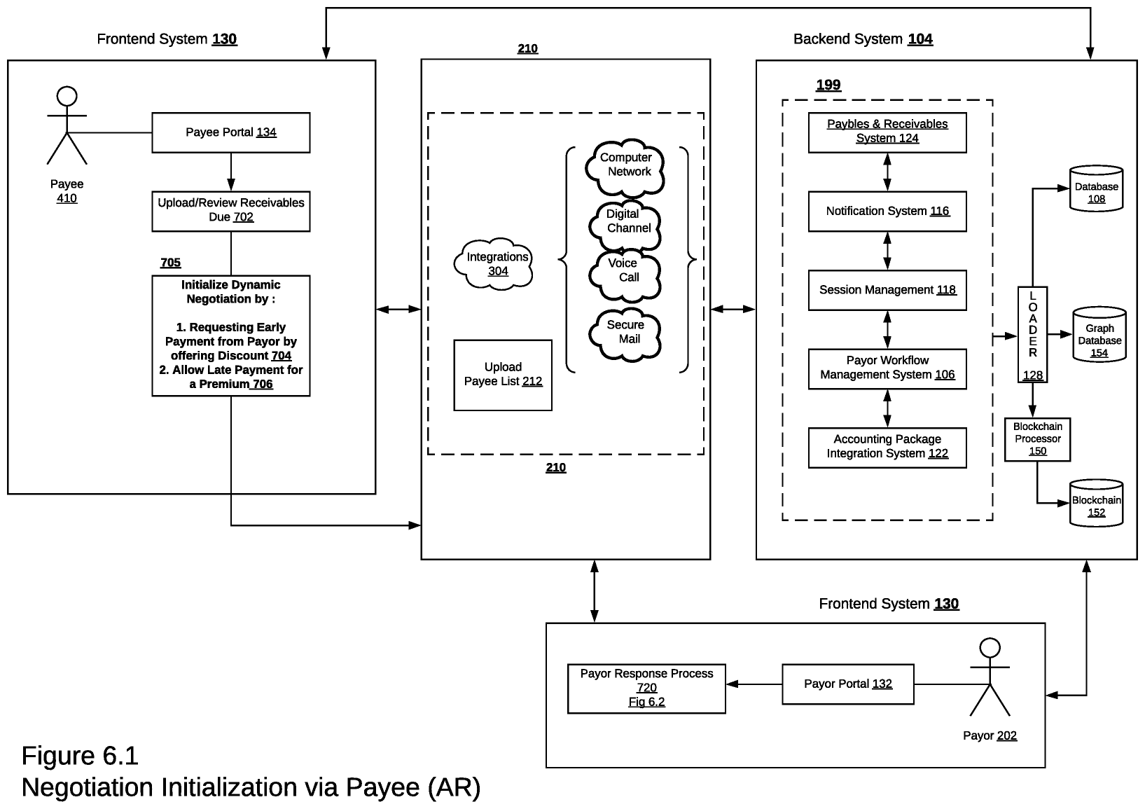

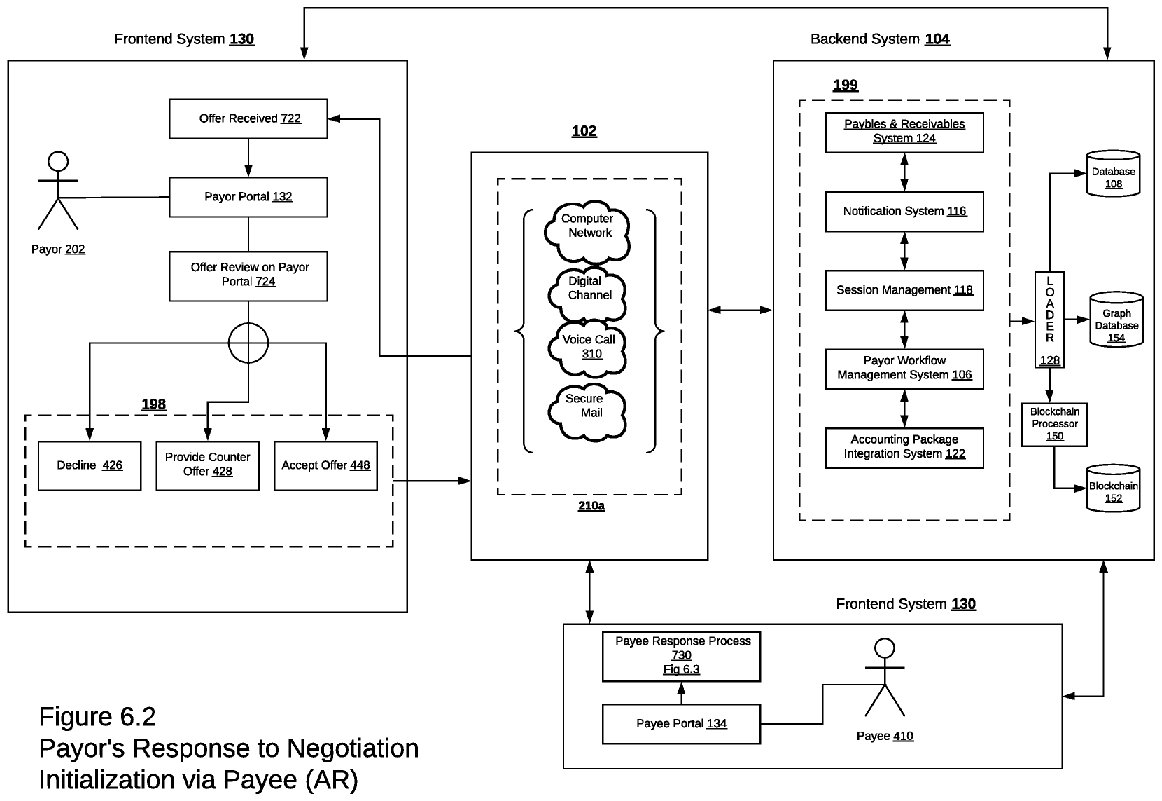

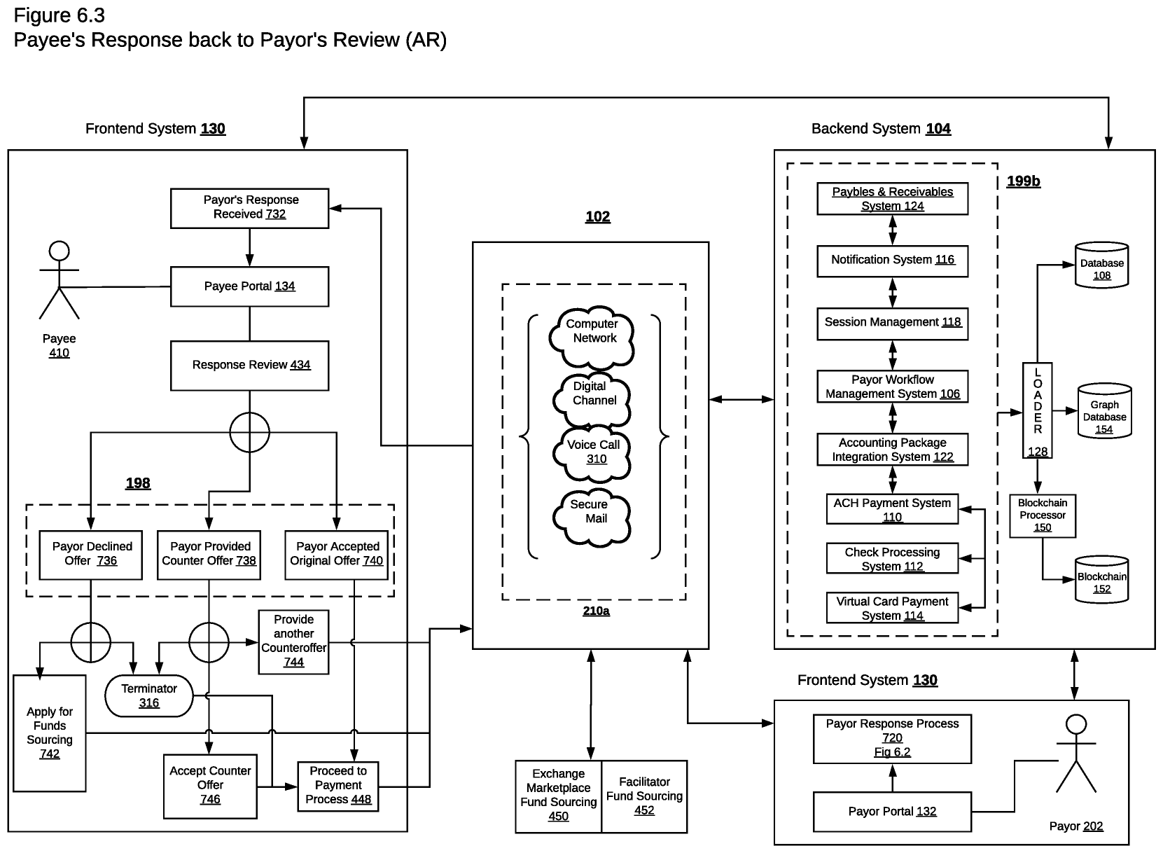

FIGS. 6.1, 6.2 and 6.3 illustrate an example of a Dynamic Negotiation System/Method (e.g., 100) between at least two parties. While FIGS. 6.1, 6.2 and 6.3 illustrate one possible example, each part or multiple parts of FIGS. 6.1, 6.2 and 6.3 may be used interchangeably with other disclosed Figure(s)/embodiment(s).

FIG. 6.1 is an example of a functional block diagram/flow chart illustrating a Negotiation Initialization via Payee (AR) method and system according to at least one or more embodiments described herein. For example, FIG. 6.1 illustrates how a user (e.g., a Payee, etc.) may initiate a negotiation with another user.

As discussed, any entity that is authorized access to the Core System/Platform may make the initial offering. Accordingly, as now illustrated in at least FIG. 6.1, the Payee may initiate the negotiations for their Account Receivables.

Similar to the Payee's review in 602, in module/step 702, the Payee may review the invoice (and/or invoice details like invoice payment status, progress in Payor/Payee payments queue, etc.) and/or review account receivables and/or upload account receivables made available by the Payor. Based on the Payee's review of the invoice, the Payee may 1) label the invoice as “complete” whereby the invoice is determined to be payable (a) in accordance with its terms or (b) subject to negotiation on a different amount and time of payment, 2) label the invoice as “incomplete” whereby the invoice is determined to be not payable until it is complete, e.g., it lacks an amount payable, and/or 3) label the invoice as partially complete or partially incomplete, whereby the invoice is determined to be payable if all the parties agree to use the Core System/Platform to negotiate payment terms, i.e., amount and timing of payment.

Similar to Module/Step 505 which includes Module/Step 504 and/or 506, in Module/Step 705 which includes Module/Step 704 and/or 706, the Payee may request the Payor early pay for a discounted payment amount 704 and/or request late payment in exchange for a premium payment 706, and/or etc. (and/or the like and/or similar other options as discussed in this disclosure).

Via a Front-End (e.g., a second Front-End) system 130, Payor 202 accesses the Core System/Platform 102 via the Payor Portal 132. Once the Payor 202 is authenticated, the Payor may access the Core System/Platform to accept an offer, reject an offer, make a counter offer etc. in response to a Payee making such an offer in module/step 720. One example of Module/Step 720 is illustrated in at least FIG. 6.2.

According to this and other embodiments, it should be noted that the Facilitator of the System may receive the offer from the sender before it is send (routed) to the recipient so that the Facilitator may decide to accept the offer, decline the offer, make a counter offer, send it to the Marketplace, approve to send the offer to the recipient, etc. giving the Facilitator the first right in each and every transaction, in each and every negotiation, etc. Aspects of the Facilitator intervention/control will be discussed in more detail in the disclosure and are not limited to only this paragraph.

FIG. 6.2 is an example of a functional block diagram/flow chart illustrating a Payor's Response to Negotiation Initialization via Payee (AR) method and system according to at least one or more embodiments described herein.

In module/step 722, the Payor 202 may receive offer(s) (e.g., to be paid early in exchange for a payment discount and/or late for a payment premium and/or the like and/or similar other options as discussed in this disclosure) from for example Payee 410.

The Payor 202 and/or, for example, an individual employee/representative of the Payor 202 may authenticate his/her authority to enter into the Payor Portal 132 through authentication (e.g., a two-factor authentication process).

Similar to Module/Step 624, in Module/Step 724, the Payor 202 may review offer(s) (e.g., the Payee's offer(s), and/or any offer(s) from users on the system) and respond accordingly, for example, to either (1) accept early payment with a discount on the face amount of the Payee's invoice or (2) accept a delayed (late) payment with a premium over the face amount of the invoice. It should be noted that the review choices may not be limited to the two disclosed options, and instead the Payor 202 may review any and all combinations of choices.

Based on the Payor's review and/or decision made, the Payor may for example a) decline the offered discount 426 and await payment in accordance with the Vendor contract, b) make a counteroffer 428 to the Payee (e.g., offer a different discount and/or offer a late payment with a premium and/or etc.) and/or c) the Payor 410 accepts Payee offer 448 (e.g., Payee discount offer and payment terms or Payee premium offer and payment terms).

As similarly illustrated in FIG. 5.2, if the Payor's response (selection) was to accept the Payee's offer and/or to Terminate, then the Payor may for example proceed directly to payment processing in accordance with the payment type selected and/or negotiated. If the any terms were not negotiated, the defaulted contract terns will be defaulted and/or the Core System/Platform's will be defaulted. For example, if the original contract had i) an amount due and ii) a due date along with iii) a currency type and it was negotiated to have a later due date with a higher amount due, then the Core System may automatically apply the original currency type and/or apply the Core System's may apply the currency transmission type (ACH, etc.) as nothing was indicated in the original contract nor the negotiations.

In Front-End (a second Front-End) system 130, the authentication of the Payee may be provided. The Payee and/or, for example, an individual employee/representative of the Payee may authenticate his/her authority to enter into the Payee Portal 134 through authentication (e.g., a two-factor authentication process).

After authentication for access to the Payee Portal 134, the Payee response process is invoked, and the Payee responds to Payor via the Core System/Portal 102. One example of Module/Step 730 is illustrated in at least FIG. 6.3.

According to this and other embodiments, it should be noted that the Facilitator of the System may receive the counteroffer from the sender before it is send (routed) to the recipient so that the Facilitator may decide to accept the counteroffer, decline the counteroffer, make a counter offer, send it to the Marketplace, approve to send the offer to the recipient, etc. giving the Facilitator the first right in each and every transaction, in each and every negotiation, etc. Aspects of the Facilitator intervention/control will be discussed in more detail in the disclosure and are not limited to only this paragraph.

FIG. 6.3 is an example of a functional block diagram/flow chart illustrating a Payee's Response back to Payor's Review AR method and system according to at least one or more embodiments described herein.

In module/step 732, the Core System/Platform sends the Payor's offer to the Payee 410. Once the Payee 410 has logged into the Front-End system 130 and passed the authentication process, the Payee 410 receives and reviews the Payor's response in Module/Step 434.

For example, the Payor's response may be that 736) the Payor has declined Payee's (a) discount offer or (b) premium offer thereby requiring payment to be made in accordance with original contract terms or 738) the Payor has made a counteroffer to Payee (different discount, different premium, different date of payment, late pay with premium, terms, etc.), or 740) the Payor has accepted the Payee's offer, or etc.

If the Payor's response was to decline the Payee's offer 736, then the negotiations is terminated via Module/Step 316 (and hence terminates any further action on invoice transaction/negotiations). However, according to this and/or any other embodiments, the Core System may also allow the Payee to make a selection, for example, to terminate via Module/Step 316 or to participate in Fund Sourcing 742. It should be note that in any and all embodiments, the system may allow a user to (at any time, at any step etc.) to select funds sourcing procedures like the one in Module/Step 742.

It should be noted that, similar Modules/Steps may function the same and hence will not be repeated (similar numbering, similar labeling, similar placement in Figures, etc.). For example, Module/Step 746 may function the same as Module/Step 646. The same is valid for 744 and 644, 748 and 648, etc.

According to this and other embodiments, it should be noted that the Facilitator of the System may receive the counteroffer from the sender before it is send (routed) to the recipient so that the Facilitator may decide to accept the counteroffer, decline the counteroffer, make a counter offer, send it to the Marketplace, approve to send the offer to the recipient, etc. giving the Facilitator the first right in each and every transaction, in each and every negotiation, etc. Aspects of the Facilitator intervention/control will be discussed in more detail in the disclosure and are not limited to only this paragraph.

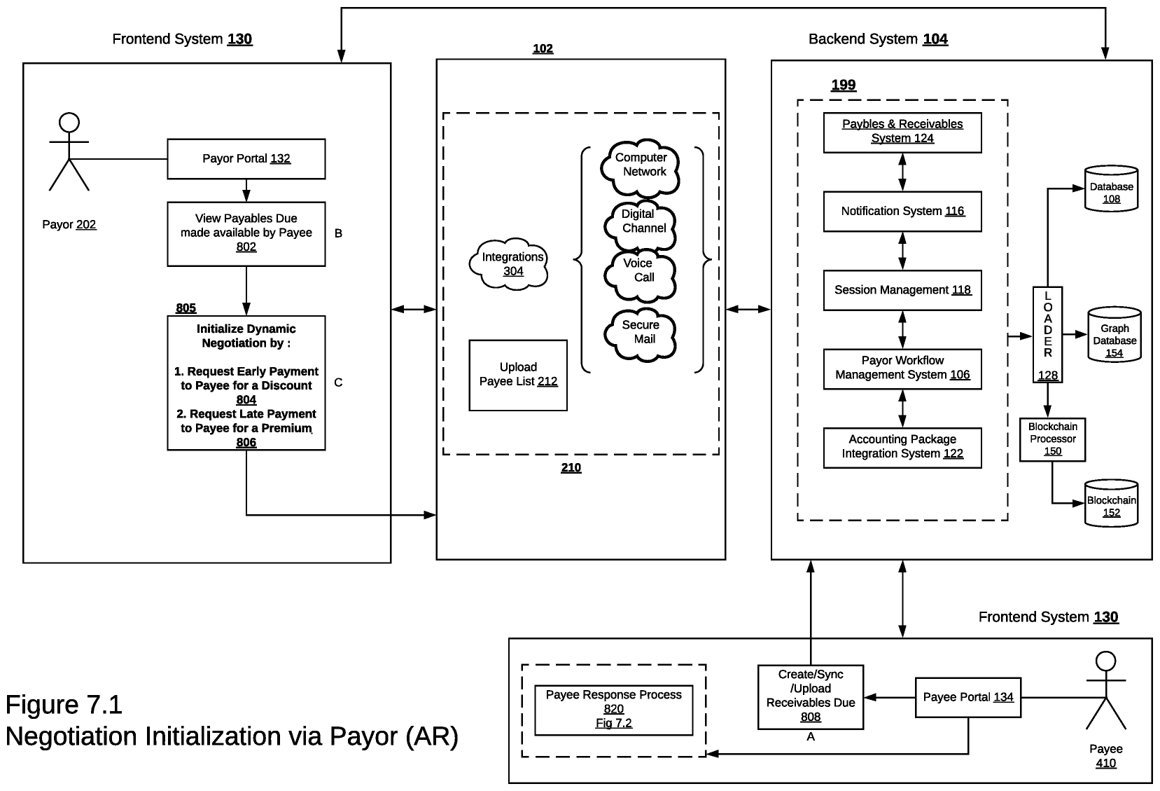

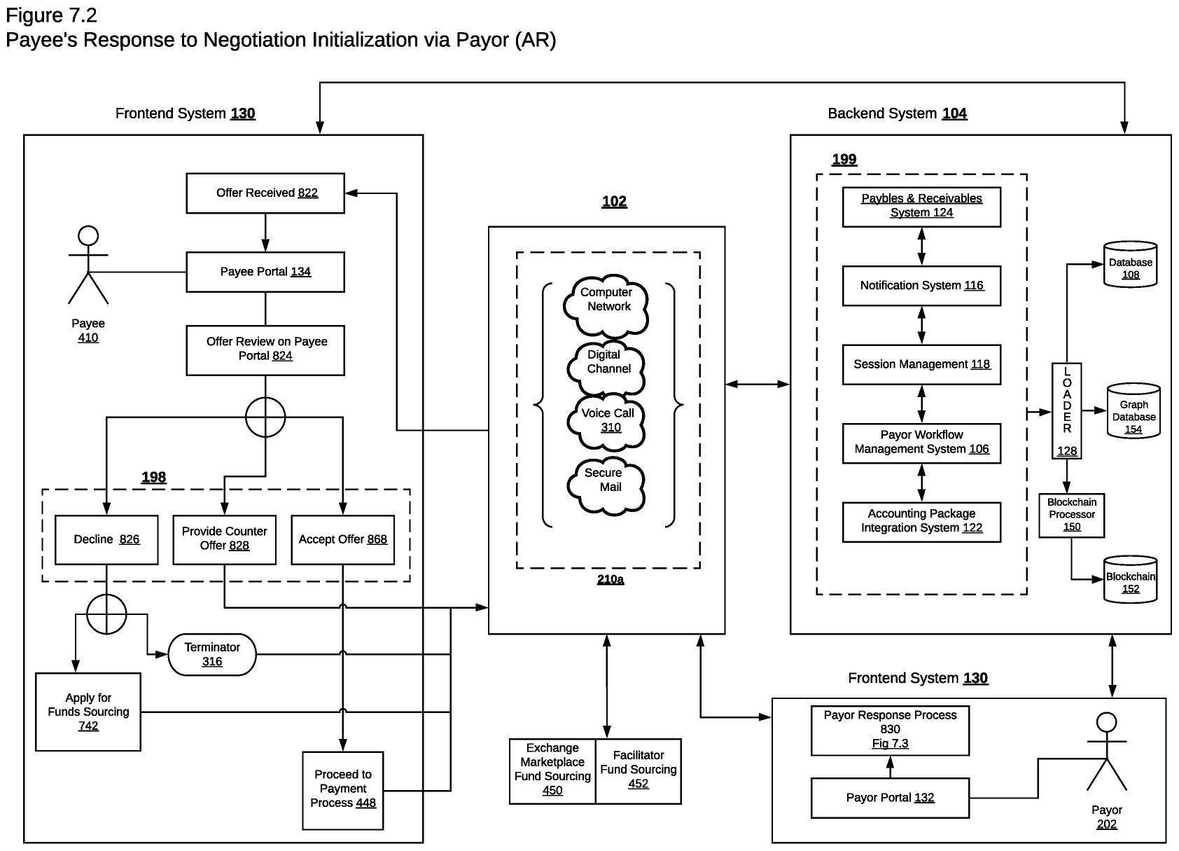

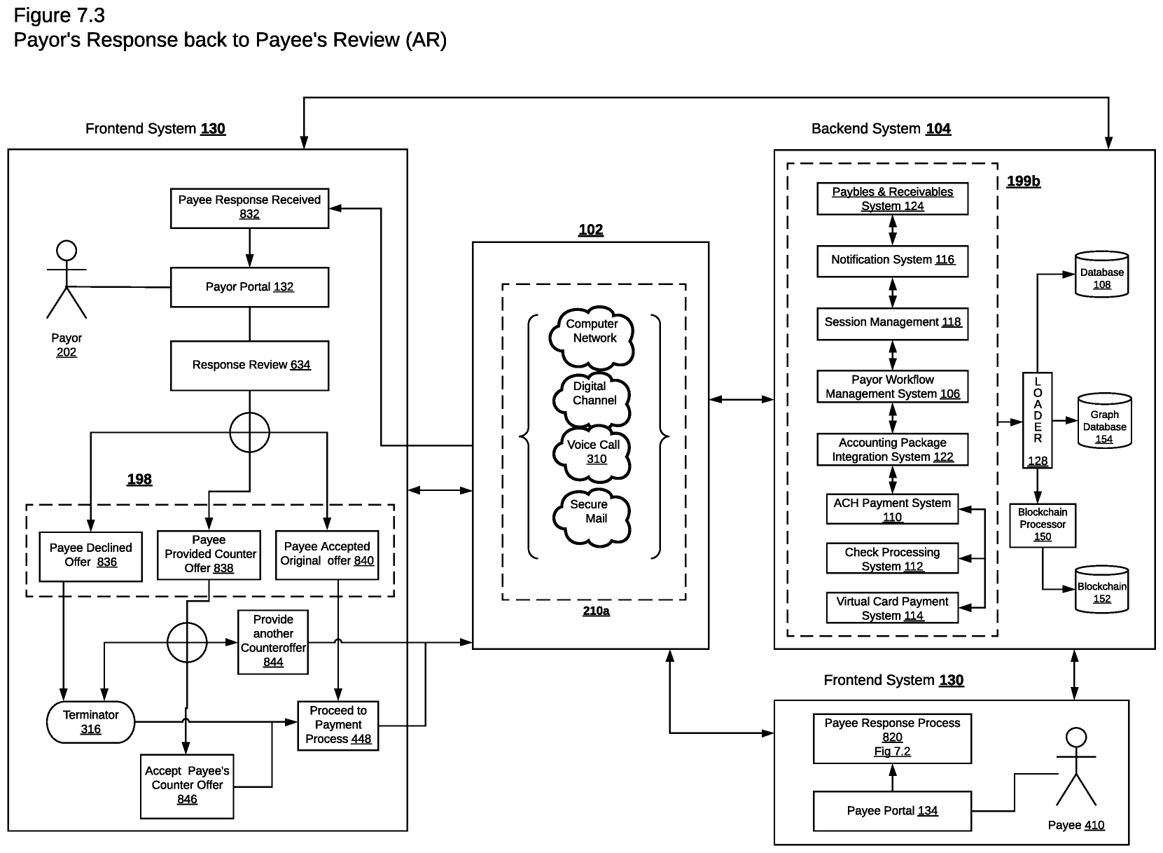

FIGS. 7.1, 7.2 and 7.3 illustrate an example of a Dynamic Negotiation System/Method (e.g., 100) between at least two parties. While FIGS. 7.1, 7.2 and 7.3 illustrate one possible example, each part or multiple parts of FIGS. 7.1, 7.2 and 7.3 may be used interchangeably with other disclosed Figure(s)/embodiment(s).

FIG. 7.1 is an example of a functional block diagram/flow chart illustrating a Negotiation Initialization via Payor Accounts Receivable (AR) method and system according to at least one or more embodiments described herein. For example, FIG. 7.1 illustrates how a user (e.g., a Payor, etc.) may initiate a negotiation with another user.

According to at least one or more embodiments, a Payor 202 (and/or multiple (types of) Payors) may access the Core System/Platform 102. For example, a Payor 202 that may access the Front-End System Platform 130 in order to perform an authentication process. The Payor (and/or, for example, an individual employee/representative of the Payor) 202 may authenticate his/her authority to enter into the Payor Portal 132 through an authentication process (e.g., a two-factor authentication process).

After an authentication process, the Payor 202 enters/accesses the Payor portal 132 in order to access/use to be able to use the System/Platform (e.g., System/Platform 100).

Similar to Module/Step 402, in Module/Step 802, Payor 202 may review the Payee's invoice and/or the Accounts Receivables (AR) may available by the Payee. Based on the Payor's review of the Payee's invoice and/or the Accounts Receivables (AR), the Payor may 1) label the invoice as “complete” whereby the invoice is determined to be payable (a) in accordance with its terms or (b) subject to negotiation on a different amount and time of payment, 2) label the invoice as “incomplete” whereby the invoice is determined to be not payable until it is complete, e.g., it lacks an amount payable, and/or 3) label the invoice as partially complete or partially incomplete, whereby the invoice is determined to be payable if all the parties agree to use the Core System/Platform to negotiate payment terms, i.e., amount and timing of payment. For example, when the invoice is marked as “complete” the Payor 202, the invoice may be sent to the second Payor approver for payment and/or to enter into Core System/Platform based negotiations for an early pay discount 804 (as similarly disclosed in Module/Step 404) and/or a late pay premium 806 (as similarly disclosed in Module/Step 406), and/or etc. (and/or the like and/or similar other options as discussed in this disclosure) or the Payor 202 may do this functionally as illustrated in the Figure themselves. It should be noted that “Complete” may include payment amount, payment timing, and related (i) purchase order, (ii) work order, and/or (iii) bill of lading, one or more of the foregoing as relevant When incomplete the invoice is returned to the Payee for additional information linking the invoice to a purchase order, work order and/or a bill of lading.

Similar to Module/Step 405, in module/step 805, the Payor 202 may offer the Payee 410 early pay for a discounted payment amount 804 (as similarly disclosed in Module/Step 404) and/or may offer late payment in exchange for a premium payment 806 (as similarly disclosed in Module/Step 406), and/or etc. (and/or the like and/or similar other options as discussed in this disclosure).

While in FIG. 7.1, it is illustrated that the Payor initiated a negotiation by requesting/offering the initial request (e.g., early pay for a discounted payment amount, late pay for a premium, etc.), according to one or more embodiments, anyone may initiate the request (anyone may make the initial offer). For example, any Payor may initiate the initial offer (and go through the process with a Payee). Alternately, any Payee may initiate the initial offer (and go through the process with a Payee). In addition, any third party (e.g., someone authorized on behalf of the Core System/Platform, a third-party (e.g., an outside financial institution, a bank, an investor, etc.) may initiate the initial offer (and go through the process with any Payee and/or Payor). Also, the Facilitator (and/or someone authorized on behalf of the Facilitator) may initiate the initial offer (and go through the process with any Payee and/or Payor). Regardless of the entity making the initial offer (except maybe for the Core System/Platform institution), the Core System/Platform institution would collect a fee for the transaction (e.g., a percentage of the premium or discount, a flat fee, etc.) In addition, if the entity making the initial offer is the Core System/Platform institution, the Core System/Platform institution may have their own incentives in making the offer like obtaining the premium by allowing late payment (while paying the Payee on time).

In addition, the Core System/Platform may operate with numerous options in addition to the pay early for a discount option and the pay later for a premium option. For example, there is another payment option in accordance with the terms of the invoice, e.g., the agreed contract terms between the parties. In addition, there may be a trade finance option, where the (1) Payor borrows funds from a third party to make payment, whether discounted, at terms, or at a premium or (2) Payee sells the account receivable to a third party who in turns looks to the Payor for payment.

Via a Front-End (e.g., a second Front-End) system 130, Payee 410 accesses the Core System/Platform 102 via the Payee Portal 134. Once the Payee 410 is authenticated, the Payee may access the Core System/Platform to accept an offer, reject an offer, make a counter offer etc. in response to a customer making such an offer in module/step 820. One example of Module/Step 820 is illustrated in at least FIG. 7.2.

In addition, in Module/Step 808 (and after authentication), the Payee 410 may edit, create, synchronize, delete, add, upload, etc. Account Receivables that are due.

According to this and other embodiments, it should be noted that the Facilitator of the System may receive the offer from the sender before it is send (routed) to the recipient so that the Facilitator may decide to accept the counteroffer, decline the offer, make a counter offer, send it to the Marketplace, approve to send the offer to the recipient, etc. giving the Facilitator the first right in each and every transaction, in each and every negotiation, etc. Aspects of the Facilitator intervention/control will be discussed in more detail in the disclosure and are not limited to only this paragraph.

FIG. 7.2 is an example of a functional block diagram/flow chart illustrating a Payee's Response to Negotiation Initialization via Payor AR method and system according to at least one or more embodiments described herein.

Similar to Module/Step 622, in module/step 822, a Payee (e.g., Payee 410) may receive offer(s) (e.g., via 306, 308, 310, and/or 312) to be paid early in exchange for a payment discount and/or late for a payment premium (and/or the like and/or similar other options as discussed in this disclosure) from a Payor (e.g., Payor 710, etc.).

The Payee (e.g., Payee 410) and/or, for example, an individual employee/representative of the Payee (e.g., Payee 410) may authenticate his/her authority to enter into the Payee Portal 134 through authentication (e.g., a two-factor authentication process).

Similar to Module/Step 424, in Module/Step 824, the Payee (e.g., Payee 410) may review offer(s) (e.g., the Payor's offer(s), and/or any offer(s) from users on the system) and respond accordingly, for example, to either (1) accept early payment with a discount on the face amount of the Payor's invoice or (2) accept a delayed (late) payment with a premium over the face amount of the invoice. It should be noted that the review choices may not be limited to the two disclosed options, and instead the Payee (e.g., Payee 410) may review any and all combinations of choices.

As similarly discussed in FIG. 4.2 and/or FIG. 5.2, in FIG. 7.2's Payee's Front-End, the Payee (e.g., Payee 410) may (based on the Payee (e.g., Payee 410) review and/or decision made) for example a) decline the offered discount 826 (as similarly disclosed in 626) and make payment in accordance with the Payor/Payee contract, b) make a counteroffer 828 (as similarly disclosed in 628) to the Payor (e.g., offer a different discount and/or offer a late payment with a premium and/or etc.) and/or c) Payee accepts Payor offer 868 (as similarly disclosed in 668) (e.g., discount/early pay offer and payment terms or premium/late pay offer and payment terms).

If the Payee's response (selection) was to decline 826 the Payee's offer and/or to Terminate, then the Payor 708 may select to terminate via 316 or to proceed directly to apply for Funds Sourcing in 742. It should also be noted that the Payee may also proceed to either 742 and/or 448 and/or 450 after selecting Terminate 316.

It should be noted that, according to at least one embodiment, Funds sourcing (e.g., in 450 and/or 452) may be the automated process of the Facilitators Core Platform by which the Facilitator may initiate and/or accept the terms of an offer made by a user on the system (e.g., a Payee and/or Payor). However, according to at least one embodiment, if the Facilitator does not choose to accept the offered terms (e.g., the requested discount or premium offer), the offered terms will be forwarded by the Facilitator to the exchange marketplace 450. The exchange marketplace 450 includes but not limited to Facilitator vetted potential fund sources on the Facilitators Core Platform to bid on and complete the offer request. For example, the exchange marketplace 450 may include Fund Sourcing users (e.g., third-party users that are not the Payee and/or the Payor on the particular transaction offered). However, according to at least one embodiment, it is possible that a Payor's offer may be forwarded to the marketplace which a Payee is enrolled in as a Fund Sourcing user where the Payee could also bid on the offer.

It should be noted that if no party accepts the terms of the proposed discount or premium transaction offer at the Marketplace 450 (e.g., via an expiration feature (3 days, 7 days, etc. from posting), via a time out feature (3 days, 7 days, etc. before the original due date of the AR/AP), etc.), the transaction may automatically default back to the original terms. Accordingly, if no party accepts the terms of the proposed discount or premium transaction offer at the Marketplace 450, the process may proceed to

If the Payee's response (selection) was to accept the offer via 868, then the Payee may 448) proceed directly to payment processing in accordance with the payment type selected and/or negotiated. If the any terms were not negotiated, the defaulted contract terns will be defaulted and/or the Core System/Platform's will be defaulted. For example, if the original contract had i) an amount due and ii) a due date along with iii) a currency type and it was negotiated to have a later due date with a higher amount due, then the Core System may automatically apply the original currency type and/or apply the Core System's may apply the currency transmission type (ACH, etc.) as nothing was indicated in the original contract nor the negotiations.

If the Payee's response (selection) was to provide a counter offer 828, the Payee may provide a counteroffer with new variables as already discussed herewith.

In Front-End (a second Front-End) system 130, the authentication of the Payor 202 may be provided. The Payor and/or, for example, an individual employee/representative of the Payor may authenticate his/her authority to enter into the Payor Portal 132 through authentication (e.g., a two-factor authentication process).

After authentication for access to the Payor's Portal 132, the Payor response process is invoked, and the Payor's responds to Payee via the Core System/Portal 102. One example of Module/Step 830 is illustrated in at least FIG. 7.3.

According to this and other embodiments, it should be noted that the Facilitator of the System may receive the counteroffer from the sender before it is send (routed) to the recipient so that the Facilitator may decide to accept the counteroffer, decline the counteroffer, make a counter offer, send it to the Marketplace, approve to send the offer to the recipient, etc. giving the Facilitator the first right in each and every transaction, in each and every negotiation, etc. Aspects of the Facilitator intervention/control will be discussed in more detail in the disclosure and are not limited to only this paragraph.

FIG. 7.3 is an example of a functional block diagram/flow chart illustrating a Payor's Response back to Payee's Review AR method and system according to at least one or more embodiments described herein.

As similarly discussed in other Figures (e.g., FIG. 4.3, etc.) in FIG. 7.3's Payor's Front-End, the Core System/Platform sends (via the communication channels 306, 308, 310, 312, etc.) the Payee's offer (and/or any and/or all offers from any user on the system having offers to send to the Payor) to the Payor 202 in Module/Step 832 (as similarly disclosed in 432). Once the Payor 202 has logged into the Front-End system 132 and passed the authentication process, the Payor 202 receives and reviews the Payee 410's response in Module/Step 634 (as similarly disclosed in 434).

For example, the Payee's response may be that 836) the Payee has declined Payor's (a) discount offer or (b) premium offer thereby requiring payment to be made in accordance with original contract terms (as similarly discussed in regard to 436) or 838) the Payee has made a counteroffer to Payor (different discount, different premium, different date of payment, late pay with premium, terms, etc.) (as similarly discussed in regard to 438) or 840) the Payee has accepted the Payor's offer, or etc. (as similarly discussed in regard to 440).

If the Payee's response was to decline the Payor's offer 836 (e.g., early pay or late pay, etc.), then the Payor may make a selection on how to proceed. For example, the Payor may select to proceed by 742) move payable to payables exchange marketplace 450 for sale to a third party(ies) and/or apply for funds sourcing 452/450, etc. or to 316) terminate further action on invoice transaction.

In Module/Step 316, the Payor may terminate further action on the invoice/negotiation transaction. In other words, if the termination is selected, the negotiation phase is completed, and the Core System/Platform is informed of such a completion (so that that the Core System/Platform can inform any or all users of the completion of negotiations). After termination, the Payor may proceed to the payment process in 448.

If the Payee's response was to provide a counteroffer to the Payor's offer 838, then the Payor may make a selection on how to proceed. For example, the Payor may select to proceed by 844) the Payor providing (another counteroffer) to the Payee, or 846) the Payor accepting the Payee's offer, or 316) terminate further action on invoice transaction. It should be noted that 838, 844 and 846 may have similar functionality as 438, 444 and 446.

If the Payee's response (selection) was to accept the Payor's offer 840, then the Payor may 448) proceed directly to payment processing in accordance with the payment type selected and/or negotiated. If the any terms were not negotiated, the defaulted contract terns will be defaulted and/or the Core System/Platform's will be defaulted. For example, if the original contract had i) an amount due and ii) a due date along with iii) a currency type and it was negotiated to have a later due date with a higher amount due, then the Core System may automatically apply the original currency type and/or apply the Core System's may apply the currency transmission type (ACH, etc.) as nothing was indicated in the original contract nor the negotiations. It should be noted that 840 may have similar functionality as 440.

According to this and other embodiments, it should be noted that the Facilitator of the System may receive the counteroffer from the sender before it is send (routed) to the recipient so that the Facilitator may decide to accept the counteroffer, decline the counteroffer, make a counter offer, send it to the Marketplace, approve to send the offer to the recipient, etc. giving the Facilitator the first right in each and every transaction, in each and every negotiation, etc. Aspects of the Facilitator intervention/control will be discussed in more detail in the disclosure and are not limited to only this paragraph.

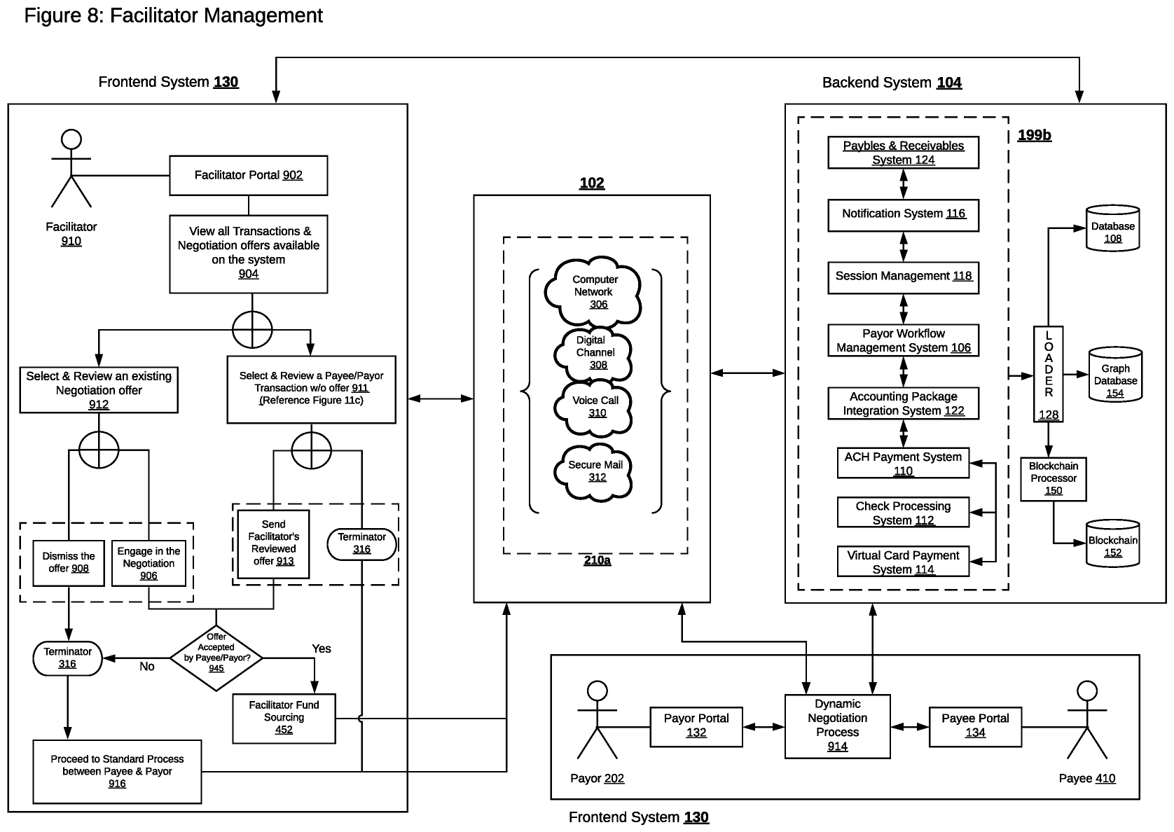

FIG. 8 is an example of a functional block diagram/flow chart illustrating a Facilitator's management and/or control over the Dynamic Negotiation Program/Process 914 (e.g., at least FIGS. 1-13) method and system according to at least one or more embodiments described herein. It should be noted that the Facilitator's management and/or control (and/or intervention) may occur before and/or after every step/module (e.g., during the entire process) in the disclosed method and system.

In the Front-End System 130, authentication of a Facilitator (e.g., the Administrator of System/Platform 101, the Host of System/Platform 101) may be provided. The Facilitator 910 and/or, for example, an individual employee/representative of the Facilitator 910 may authenticate his/her authority to enter into the Facilitator Portal 902 through authentication (e.g., a two-factor authentication process) for access to the System/Platform 102.

After an authentication process, the Facilitator 910 enters/accesses the Facilitator portal 902 in order to access/use to be able to use and/or control all aspects of the System/Platform (e.g., System/Platform 100/System/Platform 102) including the user communications/negotiations.

The Facilitator 910 can view all transactions, all communications, and all negotiations, all offers, etc. at/in Module/Step 904. Accordingly, the Facilitator 910 may select to review any communications like an offer at any step in the Dynamic Negotiation Program, including a review (and approval) from the very first step of a user making an initial offer e.g., starting negotiations (e.g., 405, 505, etc.) to the conclusion of a user accepting an offer (e.g., 448, 440, 668, etc.), declining an offer (e.g., 426, 436, 626, etc.), terminating an offer/negotiations (e.g., 218, 316, etc.) making a counteroffer (e.g., 428, 438, 444, 628,), applying for funds sourcing, etc.

For example, the Facilitator 910 can select via 912 to view all existing negotiations (e.g., from the moment a user selects to start/submit an offer). Based on the Facilitator 910's selection of 911, the Core System/Platform will review all existing Payee/Payor transactions. The Facilitator may be the direct recipient of the offer and view each offer and make a decision on how to proceed: accept, decline, counter or terminate or forward to the Marketplace, etc. The Facilitator may view, evaluate, accept, counter or decline, etc. all available offers. The Facilitator at any time may accept the terms of any proposed offer.

If the Facilitator selects to Dismiss an offer 908, the review of the Facilitator (at that point of the transaction) may be terminated and the Core System/Platform 102 will allow the negotiations to continue between the two parties (between Payor and Payee, between Payor and third-party investor, etc.). Accordingly, if the Facilitator selects to Dismiss an offer 908, the process proceeds to Terminator 316 which then proceeds to the standard process between the two parties in 916. The process of 916 may for example proceed to a payment processing step/module like 448, and/or for making a request for funding in 742, and/or 450/452, etc.

According to one or more embodiments, the Facilitator 910 may also search the existing transactions for specific transaction types, like initial offers only, etc.—this search feature may be incorporated in 904, 912, 911, etc.

However, if the Facilitator (intercepts and) reviews and selects an offer sent from one party to another party (e.g., a Payor to a Payee, a Payee to a Payor, etc.), the Facilitator may (for example, in 906) take over the negotiations and make a decision (e.g., 198), for example, to accept the offer, to decline the offer, to make a counteroffer, etc. For example, 906 depicts the facilitator engaging in an existing negotiation of an offer.

After 236 (and 913), at step/module 945, the determination of whether the offer is accepted is made. If the offer is accepted then the process proceeds to 452, if not, it proceeds to the Terminator 316.

For example, the Facilitator 910 can select via 911 to view all transactions with no pending negotiations (e.g., transactions that have not started in negotiations and/or transactions that have already ended negotiations). Based on the Facilitator 910's selection of 911, the Core System/Platform will present all transactions with no pending negotiations to the Facilitator. The Facilitator may view each of these transactions and make a decision on how to proceed, like making an offer, viewing the next available transactions, dismissing that transactions and viewing the next available offer, etc.

The Facilitator 910 may select in 911 to terminate the process via 316. However, the Facilitator 910 may select in 911 to initiate an offer via 913. Accordingly, the Facilitator and the user associated with the selected AR/AP will partake in negotiations. If the offer is accepted in 945, Facilitator Fund sourcing 452 will occur (but the Facilitator may also decide to send the offer to the Marketplace 450).

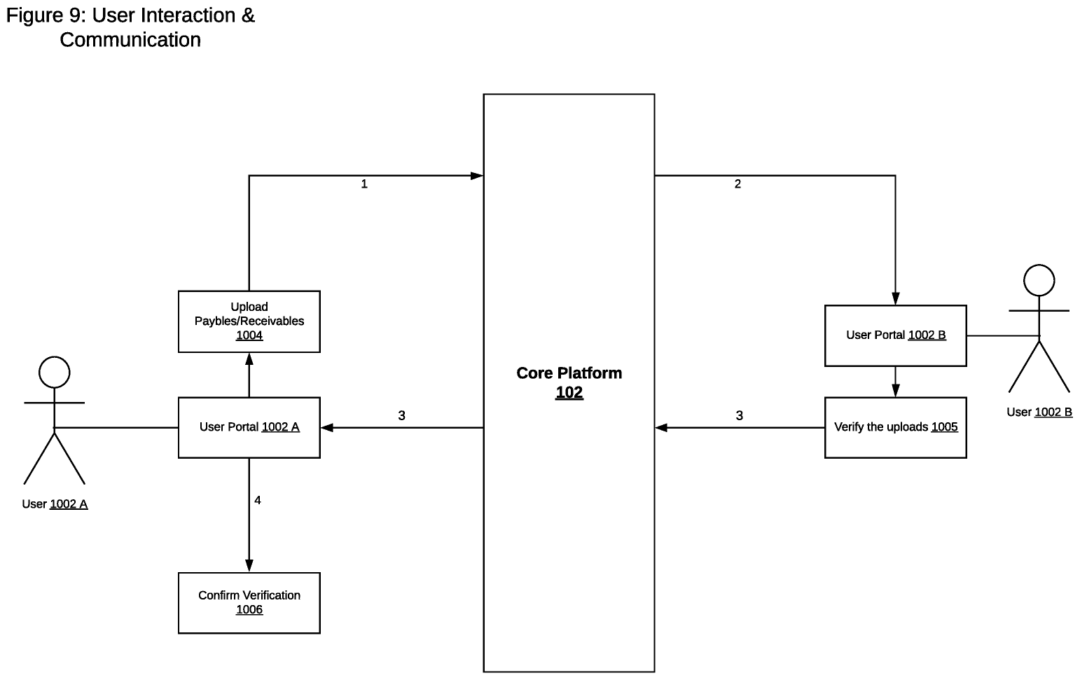

FIG. 9 is an example of a functional block diagram/flow chart illustrating user interaction and communication using the Dynamic Negotiation Process/Program (e.g., at least FIGS. 1-13) method and system according to at least one or more embodiments described herein.

FIG. 9 is an example interaction and communication flow between at least two users according to one or more embodiments described herein where one user may be for example the Payor and the other user may be for example the Payee. Accordingly, each user accesses the Core Platform 102 via their respective User Portal.

After being authorized to access the Core Platform 102, User 1002a may upload information/document(s) like Payables and/or Receivables 1004. The information/document(s) are uploaded to the database of the Core Platform 102. Accordingly, the second user 1002b (which would be the second party to the transaction of an AR/AP) may verify and accept the upload information/document(s).

If either party discovers any discrepancies in the uploaded information/document(s), the communication cycles between the users until the information/document(s) are confirmed and/or accepted by both/all parties (thereby providing a means of mutually agreed upon terms). For example, an invoice with terms (e.g., a due date, an amount due, payment transmission method (ACH, wire, etc.), type of funds (USD, EURO, etc.), etc.) may be uploaded by one (Payee) user and the second (Payor) user may review the invoice to ensure all of the terms are correct and either accept or send back a correction(s).

FIG. 9 is an example of a functional block diagram/flow chart illustrating user interaction and communication using the Dynamic Negotiation Process/Program (e.g., at least FIGS. 1-13) method and system according to at least one or more embodiments described herein. For example, FIG. 9 is an example of a functional block diagram/flow chart illustrating communication between users of any roles, e.g., a Payor and Payee, etc. According to one or more embodiments, FIG. 9 illustrates that user 1002A may upload payable/receivable invoices via access to their portal. User 1002 B may log into the user portal, via the Core Platform, to view and/or verify the upload(s) made by another user (e.g., by user 10002 A). Once user 1002 B verify an upload(s), user 1002 A may confirm user's 1002 B's verification of accurate payable/receivable and user 1002 A may proceed further with the payment process (negotiation process, etc.).

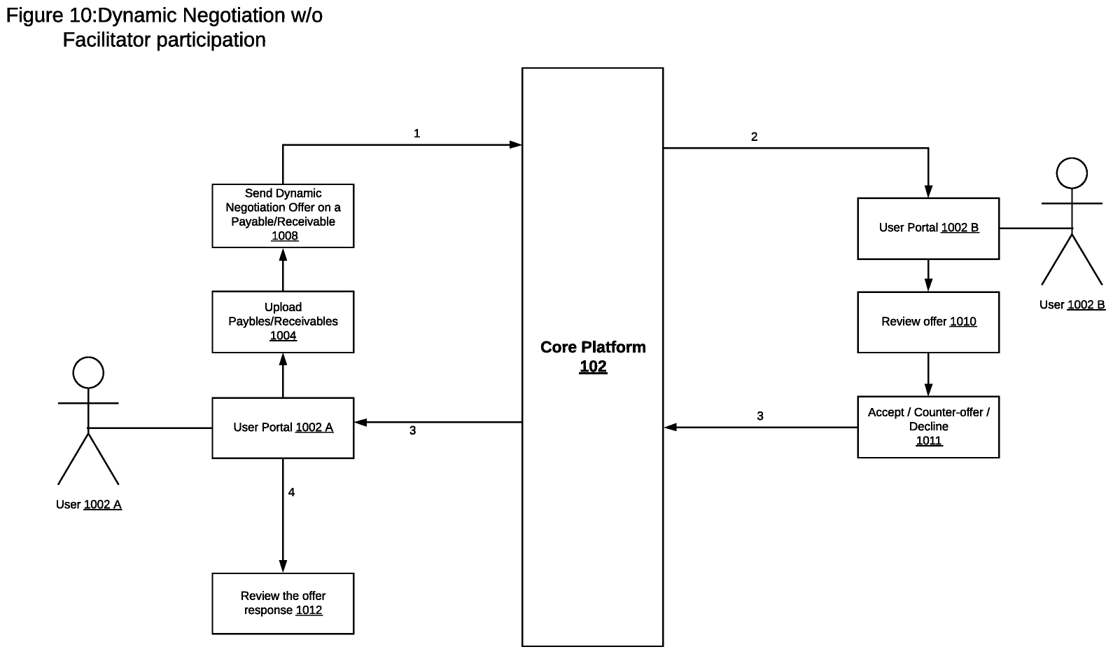

FIG. 10 is an example of a functional block diagram/flow chart illustrating the Dynamic Negotiations Process without the Facilitator actively participating in the Process according to at least one or more embodiments described herein.

After being authorized to access the Core Platform 102, User 1002a may upload information/document(s) like Payables and/or Receivables 1004. The information/document(s) are uploaded to the database of the Core Platform 102. Accordingly, the second user 1002b (which would be the second party to the transaction of an AR/AP) may verify and accept the upload information/document(s).

If either party discovers any discrepancies in the uploaded information/document(s), the communication cycles between the users until the information/document(s) are confirmed and/or accepted by both/all parties (thereby providing a means of mutually agreed upon terms). For example, an invoice with terms (e.g., a due date, an amount due, payment transmission method (ACH, wire, etc.), type of funds (USD, EURO, etc.), etc.) may be uploaded by one (Payee) user and the second (Payor) user may review the invoice to ensure all of the terms are correct and either accept or send back a correction(s).

In FIG. 10, after user 1002a uploads the information/document(s), the user 1002a has the option to 1008 initiate the Dynamic Negotiation Process via making an offer on the original terms of an Account Receivable/Account Payable to be sent to the user 1002b via the Core Platform 102.

In response to user 1002a's offer, user 1002b may review the offer made 1010 and user 1002b may respond to the offer (e.g., accept, counter, decline, etc.) 1011.

FIG. 10 is an example of a functional block diagram/flow chart illustrating the Dynamic Negotiations Process between user 1002A and user 1002 B without (e.g., the need for) the Facilitator participation and/or intervention. It should be noted that the numbering (“1,” “2,” “3,” “4,” . . . ) in this Figure and other Figures illustrates the actions/steps that are performed by the user. FIG. 10 is a high-level overview of for example FIGS. 4-7 and illustrating one example of how User 1002 A sends a negotiation offer (1) on a Payable/Receivable invoice and the offer is made available to User 1002 B via Core Platform (2). User 1002 B may then respond (3) to the offer after having reviewed it. User 1002 A then may finally review User 1002 B's response (4) on the original offer and proceeds accordingly.

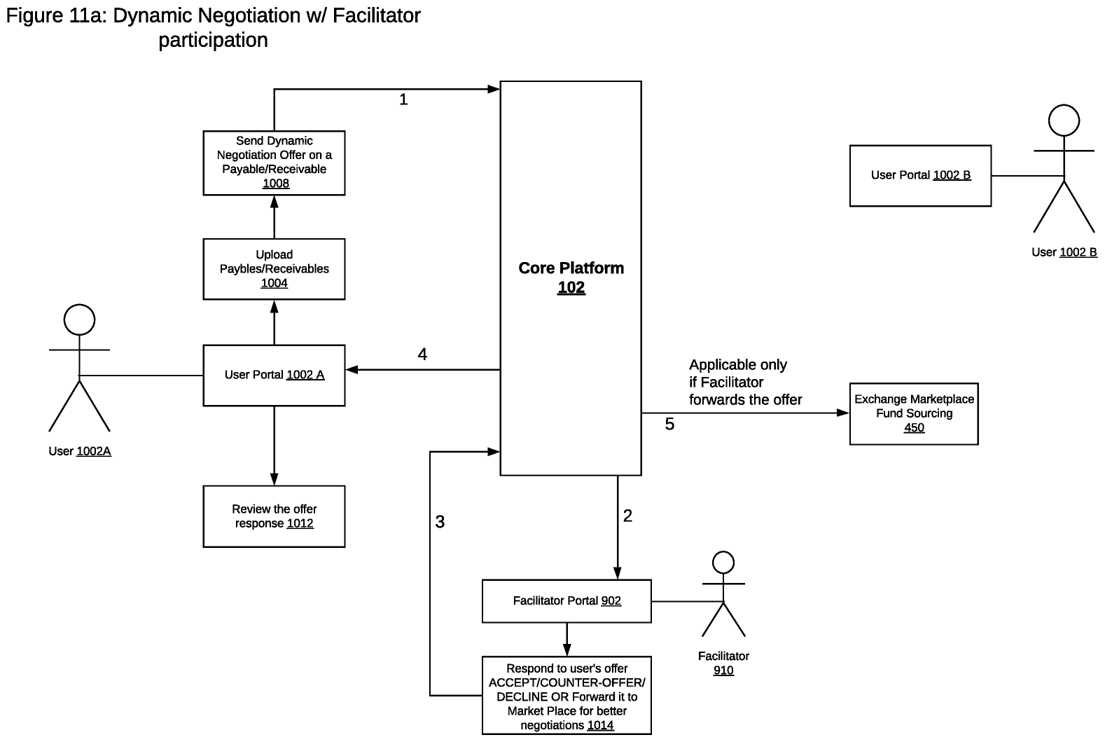

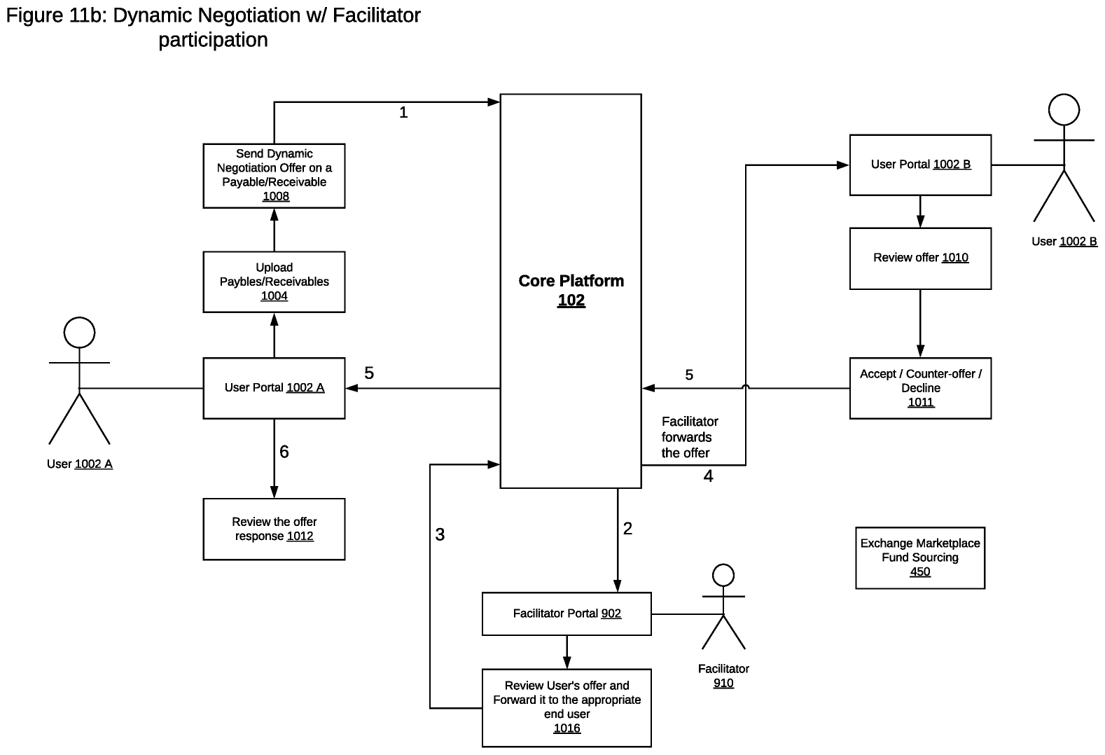

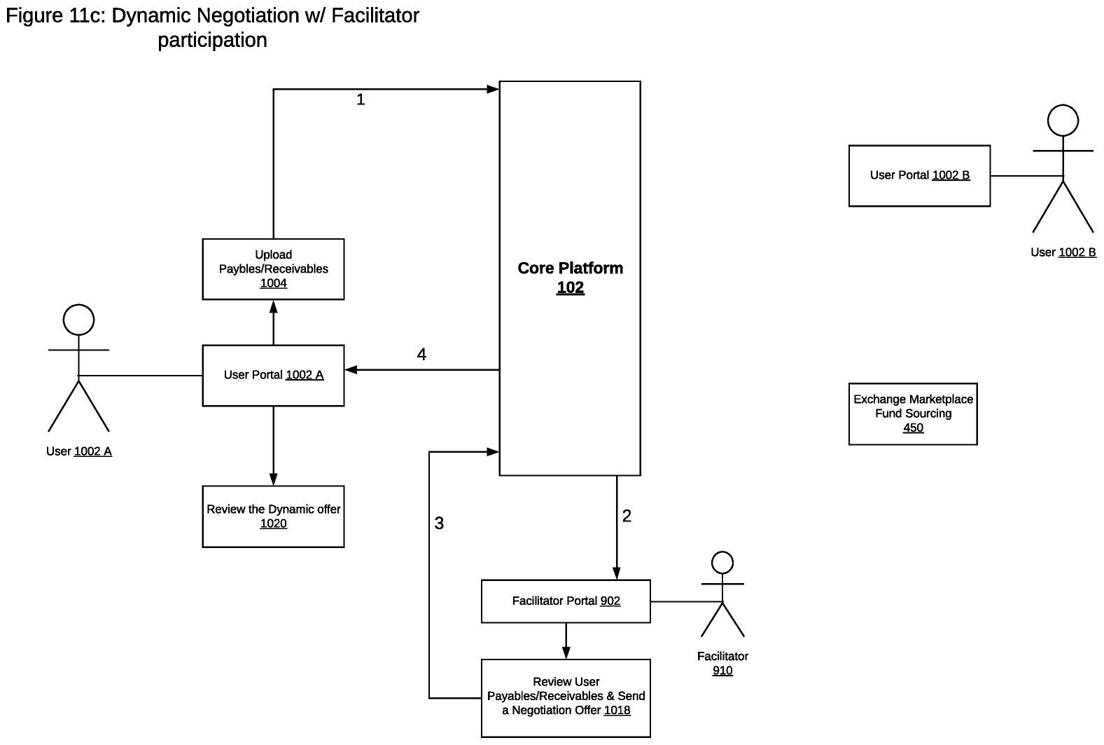

FIG. 11a is an example of a functional block diagram/flow chart illustrating the Dynamic Negotiation Process/Program (e.g., at least FIGS. 1-13) with Facilitator interaction method and system according to at least one or more embodiments described herein.

After being authorized to access the Core Platform 102, User 1002a may upload information/document(s) like Payables and/or Receivables 1004. The information/document(s) are uploaded to the database of the Core Platform 102. Accordingly, the second user 1002b (which would be the second party to the transaction of an AR/AP) may verify and accept the upload information/document(s).

If either party discovers any discrepancies in the uploaded information/document(s), the communication cycles between the users until the information/document(s) are confirmed and/or accepted by both/all parties (thereby providing a means of mutually agreed upon terms). For example, an invoice with terms (e.g., a due date, an amount due, payment transmission method (ACH, wire, etc.), type of funds (USD, EURO, etc.), etc.) may be uploaded by one (Payee) user and the second (Payor) user may review the invoice to ensure all of the terms are correct and either accept or send back a correction(s).

After user 1002a uploads the information/document(s), the user 1002a has the option to 1008 initiate the Dynamic Negotiation Process via making an offer on the original terms of an Account Receivable/Account Payable to be sent to the user 1002b via the Core Platform 102.

In FIG. 11a, Facilitator 910 access the Core Platform via the Facilitator Portal 902. Once the Facilitator 910 has access to the Core Platform, the Facilitator may review any and all communications, offers, etc. that flow through the Core Platform.

Accordingly, after User 1002a makes/transmits an offer to be sent over to User 1002b, Facilitator intercepts the offer made as the Facilitator may oversee all communications/offers on the system.

Facilitator 910 may review the offer transmitted by the User 1002a and make a decision on the offer. For example, Facilitator 910 may accept the offer (e.g., on behalf of the User 1002b, on behalf of the Facilitator, on behalf of the third party fund sourcer, investor, etc.), reject/decline the offer (e.g., on behalf of the User 1002b, on behalf of the Facilitator, on behalf of the third party fund sourcer, investor, etc.), counter the offer (e.g., on behalf of the User 1002b, on behalf of the Facilitator, on behalf of the third party fund sourcer, investor, etc.), forward the offer to the marketplace, etc.

According to one or more embodiments, any and all requests to send an offer and/or an AR/AP to the Marketplace may be reviewed and/or approved by the Facilitator prior to granting (or declining) the offer and/or an AR/AP to be sent to the Marketplace. One of many benefits of this review prior to forwarding to the Marketplace is that the Facilitator may find the offer presented to be very favorable. For example, if a first user that owes 100,000 USD to a second user in 12 months and the first user states that the payment will be made prior to the first month if a discount of 1,000 USD is provided. Accordingly, the Facilitator may make an offer to the second user that the payment will be made prior to the fourth month if a discount of 5,000 USD is provided. Accordingly, if the second user accepts this arraignment, a profit of 4,000 USD is made, and the Facilitator may hold the 99,000 for three months earning interest prior to releasing the 95,000 to the second user.

FIG. 11a is an example of a functional block diagram/flow chart illustrating the Dynamic Negotiations Process between user 1002A and user 1002 B with the Facilitator participation and/or intervention where User 1002 A sends an (negotiation) offer (1) on a Payable/Receivable invoice and the offer is made available to via Core Platform (2) to Facilitator. The Facilitator then has an option to either send a response back (3) to User 1002 A (Accept/Decline/Counter-offer), forward the negotiation offer to Exchange Marketplace for better negotiations, etc. Accordingly, the Facilitator may decide to send a response, which User 1002 A then reviews Facilitator's response (4) on the original offer and proceeds accordingly. Otherwise the offer is available on Exchange Marketplace (5) for external fund sourcing, etc.

FIG. 11b is another example of a functional block diagram/flow chart illustrating the Dynamic Negotiation Process/Program (e.g., at least FIGS. 1-13) with Facilitator interaction method and system according to at least one or more embodiments described herein.

After being authorized to access the Core Platform 102, User 1002a may upload information/document(s) like Payables and/or Receivables 1004. The information/document(s) are uploaded to the database of the Core Platform 102. Accordingly, the second user 1002b (which would be the second party to the transaction of an AR/AP) may verify and accept the upload information/document(s).

If either party discovers any discrepancies in the uploaded information/document(s), the communication cycles between the users until the information/document(s) are confirmed and/or accepted by both/all parties (thereby providing a means of mutually agreed upon terms). For example, an invoice with terms (e.g., a due date, an amount due, payment transmission method (ACH, wire, etc.), type of funds (USD, EURO, etc.), etc.) may be uploaded by one (Payee) user and the second (Payor) user may review the invoice to ensure all of the terms are correct and either accept or send back a correction(s).

After user 1002a uploads the information/document(s), the user 1002a has the option to 1008 initiate the Dynamic Negotiation Process via making an offer on the original terms of an Account Receivable/Account Payable to be sent to the user 1002b via the Core Platform 102.

In Figure lib, Facilitator 910 access the Core Platform via the Facilitator Portal 902. Once the Facilitator 910 has access to the Core Platform, the Facilitator may review any and all communications, offers, etc. that flow through the Core Platform.

Accordingly, after User 1002a makes/transmits an offer to be sent over to User 1002b, Facilitator intercepts the offer made as the Facilitator may oversee all communications/offers on the system.

In Step/Module 1016 of FIG. 11b, the Facilitator reviews User 1002a's offer made to User 1002b and decides not to accept, counter, send to marketplace, etc. and instead approves the offer to be forwarded to User 1002b as User 1002a intended.

In one or more aspects, FIG. 11b is similar to FIG. 11a except for example, it is illustrated that the Facilitator after having reviewed User 1002 A's (negotiation) offer forwards the offer to the appropriate user on the other end instead of forwarding it to a marketplace for external fund sourcing. In this example case, User 1002 B may review the offer and responds accordingly (Accept/Decline/Counter-offer/etc.).

FIG. 11c is an example of a functional block diagram/flow chart illustrating the Dynamic Negotiation Process/Program (e.g., at least FIGS. 1-13) with Facilitator initiation method and system according to at least one or more embodiments described herein.

After being authorized to access the Core Platform 102, User 1002a may upload information/document(s) like Payables and/or Receivables 1004. The information/document(s) are uploaded to the database of the Core Platform 102. Accordingly, the second user 1002b (which would be the second party to the transaction of an AR/AP) may verify and accept the upload information/document(s).

If either party discovers any discrepancies in the uploaded information/document(s), the communication cycles between the users until the information/document(s) are confirmed and/or accepted by both/all parties (thereby providing a means of mutually agreed upon terms). For example, an invoice with terms (e.g., a due date, an amount due, payment transmission method (ACH, wire, etc.), type of funds (USD, EURO, etc.), etc.) may be uploaded by one (Payee) user and the second (Payor) user may review the invoice to ensure all of the terms are correct and either accept or send back a correction(s).

In FIG. 11c, Facilitator 910 may access the Core Platform via the Facilitator Portal 902. Once the Facilitator 910 has access to the Core Platform, the Facilitator may review any and all communications, offers, etc. that flow through the Core Platform.

In FIG. 11c, even when there are no offers currently in negotiations, no offers made to date, negotiations have been terminated, etc. Facilitator 910 may review any and all Account Payables/Account Receivable (including pending invoices and/or accounts, outstanding invoices and/or accounts, etc.), and (at any time) send a negotiation offer to either or both parties thereby initiating negotiations. Facilitator 910 may also send the offer contingent for the Facilitator 910 to make the final approval, so the Facilitator 910 is not stuck with a later determined unattractive transaction of an accepted offer.

Similarly, even when there are no offers currently in negotiations, no offers made to date, negotiations have been terminated, etc. Facilitator 910 may review any and all Account Payables/Account Receivable (including pending invoices and/or accounts, outstanding invoices and/or accounts, etc.), and (at any time) send the Account Payables/Account Receivable (including pending invoices and/or accounts, outstanding invoices and/or accounts, etc.) to the Marketplace. Facilitator 910 may also send the Account Payables/Account Receivable to the Marketplace contingent for the Facilitator 910 to make the final approval so the Facilitator 910 is not stuck with a transaction that should not have been sent to the Marketplace.

It should be noted that in FIG. 11c, the Facilitator (has the authority to) views any or all on-going/uploaded payable/receivable transactions and/or invoices by User 1002 A (1) on the system and initiate a negotiation/offer directly (2 & 3) to the appropriate user instead of waiting for the user to do something (make an offer, counter, etc.).

FIG. 12 is a circuit diagram of one aspect of a computing device/controller 1000 that works in conjunction with the elements of the present disclosure. In a very basic configuration of computing device 1000, the computing device 1000 typically includes one or more processors 1010 and a system memory 1020. A memory bus 1030 can be used for communications between the processor 1010 and the system memory 1020.

Depending on the desired configuration, the one or more processor 1010 of computing device 1000 can be of any type including but not limited to a microprocessor, a microcontroller, a digital signal processor, or any combination thereof. Processor 1010 can include one more levels of caching, such as a level one cache 1011 and a level two cache 1012, a processor core 1013, and registers 1014. The processor core 1013 can include an arithmetic logic unit (ALU), a floating point unit (FPU), a digital signal processing core (DSP Core), or any combination thereof. A memory controller 1015 can also be used with the processor 1010, or in some implementations the memory controller 1015 can be an internal part of the processor 1010.

Depending on the desired configuration, the system memory 1020 can be of any type including but not limited to volatile memory (such as RAM), non-volatile memory (such as ROM, flash memory, etc.) or any combination thereof. System memory 1020 typically includes an operating system 1021, one or more applications 1022, and program data 1024. Application 1022 includes an authentication algorithm 1023. Program Data 1024 includes service data 1025.

Computing device 1000 can have additional features or functionality, and additional interfaces to facilitate communications between the basic configuration 1001 and any required devices and interfaces. For example, a bus/interface controller 1040 can be used to facilitate communications between the basic configuration 1001 and one or more data storage devices 1050 via a storage interface bus 1041. The data storage devices 1050 can be removable storage devices 1051, non-removable storage devices 1052, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media can include volatile and nonvolatile, removable and non-removable media implemented in any method or technology for storage of information, such as computer readable instructions, data structures, program modules, or other data

System memory 1020, removable storage 1051 and non-removable storage 1052 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing device 1000. Any such computer storage media can be part of the computing device 1000.

Computing device 1000 can also include an interface bus 1042 for facilitating communication from various interface devices (e.g., output interfaces, peripheral interfaces, communication interfaces, etc.) to the basic configuration 1001 via the bus/interface controller 1040. Example output devices 1060 include a graphics processing unit 1061 and an audio processing unit 1062, which can be configured to communicate to various external devices such as a display or speakers via one or more A/V ports 1063. Example peripheral interfaces 1070 include a serial interface controller 1071 or a parallel interface controller 1072, which can be configured to communicate with external devices such as input devices (e.g., keyboard, mouse, pen, voice input device, touch input device, etc.) or other peripheral devices (e.g., printer, scanner, etc.) via one or more I/O ports 1073. An example communication device 1080 includes a network controller 1081, which can be arranged to facilitate communications with one or more other computing devices 1090 over a network communication via one or more communication ports 1082. The communication connection is one example of a communication media.

Communication media may typically be embodied by computer readable instructions, data structures, program modules, or other data in a modulated data signal, such as a carrier wave or other transport mechanism, and includes any information delivery media. A “modulated data signal” can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared (IR) and other wireless media. The term computer readable media as used herein can include both storage media and communication media.

It should be noted that the specifying circuit 112, the buffer specifier 114, the segmenter 311, the transformer 312, the periodogram computer 313, the delay assessment circuit 118, the pre-processors 110 and 111, the first and second threshold circuit 130 and 131, and/or the first and the second shift register 150, 151 may work in conjunction with computing device 600. In addition, it should be noted that the specifying circuit 112, the buffer specifier 114, the segmenter 311, the transformer 312, the periodogram computer 313, the delay assessment circuit 118, the pre-processors 110 and 111, the first and second threshold circuit 130 and 131, and/or the first and the second shift register 150, 151 may be comprised directly of the elements of computing device 1000 (i.e., elements 1010 and/or 1020).

Computing device 1000 can be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 1000 can also be implemented as a personal computer including both laptop computer and non-laptop computer configurations.

There is little distinction left between hardware and software implementations of aspects of systems; the use of hardware or software is generally (but not always, in that in certain contexts the choice between hardware and software can become significant) a design choice representing cost versus efficiency tradeoffs. There are various vehicles by which processes and/or systems and/or other technologies described herein can be effected (e.g., hardware, software, and/or firmware), and the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation. In one or more other scenarios, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof.

In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Exemplary embodiments are shown and described in the present disclosure. It is to be understood that the embodiments are capable of use in various other combinations and environments and are capable of changes or modifications within the scope of the inventive concept as expressed herein. Some such variations may include using programs stored on non-transitory computer-readable media to enable computers and/or computer systems to carry our part or all of the method variations discussed above. Such variations are not to be regarded as departure from the spirit and scope of the invention, and all such modifications as would be obvious to one skilled in the art are intended to be included within the scope of the following claims.

1. An apparatus comprising:
a communication unit configured and/or programmed to separately receive account information from both a first user and a second user, wherein
the account information includes at least i) an information identification or invoice number ii) an amount of a commodity, iii) a due date corresponding to the amount of the commodity, iv) identification information of the first user and v) identification information of the second user,
a processing unit configured and/or programmed to:
match the account information received from the first user to the account information received from the second user based on i) the information identification or invoice number, ii) identification information of the first user and iii) identification information of the second user, and
assign a transaction to the matched account information, wherein the processing unit configured and/or programmed to:
determine whether or not the amount of the commodity received from the first user numerically corresponds the amount of the commodity received from the second user,
determine whether or not the amount of the due date received from the first user corresponds the due date received from the second user, wherein
the communication unit is further configured and/or programmed to:
assign and/or label the transaction as an inaccurate transaction and send:
a request for new commodity amount data in the case that a determination was made that the amount, of the commodity received from the first user did not numerically correspond to the amount of the commodity received from the second user, and/or
a request for new due date information in the case that a determination was made that the amount of the due date received from the first user did not correspond to the due date received from the second user, wherein
the transaction is assigned and/or label as an accurate transaction in a case that both
a determination was made that the amount of the commodity received from the first user does numerically correspond to the amount of the commodity received from the second user,
a determination was made that the amount of the due date received from the first user does correspond to the due date received from the second user,
the processing, unit is further configured and/or programmed to
search a group of transactions based on a criterion that no offers select a first transaction m said group of transactions based on a Facilitator user input, wherein
the first transaction includes a first amount due and a first due date,
the communication unit is further configured and/or programmed to receive a second amount due based on the Facilitator user input,
the communication unit is further configured and/or programmed to receive a second due date based on the Facilitator user input,
the communication unit is further configured and/or programmed to send an offer to the second user with the second amount due and the second due date, wherein
the second amount due is different than the first amount due, and
the second due date is different than the first due date.

2-4. (canceled)

5. The apparatus according to claim 1, wherein
the second amount due is less than the first amount due, and
the second due date is earlier than the first due date.

6. The apparatus according to claim 1, wherein
the second amount due is greater than the first amount due, and
the second due date is later than the first due date.

7. The apparatus according to claim 1, wherein
the communication unit is further configured and/or programmed to receive a response from the second user in response to said offer.

8-9. (canceled)

10. The apparatus according to claim 1, wherein
the response from the second user in response to said offer is an acceptance of the offer,
the processing unit is further configured and/or programmed to:
inform the first user that the transaction is transferred from the second user to the Facilitator user, and/or
assign the transaction from the second user to the Facilitator user.

11. The apparatus according to claim 10, wherein
the Facilitator user having a Facilitator user account for receiving, holding and/or transferring funds,
the first user having a first user account for receiving, holding and/or transferring funds,
the second user having a second user account for receiving, holding and/or transferring funds,
the processing unit is further configured and/or programmed to:
transfer funds from the Facilitator user account to said second user account on or prior to said second due date, wherein
said funds transferred from the Facilitator user account to said second user account corresponds to said second amount due.

12. The apparatus according to claim 11, wherein
the processing unit is further configured and/or programmed to:
transfer funds from the first user account to said Facilitator user account on or prior to said first due date, wherein
said funds transferred from the first user account to said Facilitator user account corresponds to said first amount due.

13. The apparatus according to claim 1, wherein
the processing unit is further configured and/or programmed to:
process an offer sent from the first user to the second user, wherein
the offer is a request to change a first amount due and a first due date of a first transaction to a second amount due and a second due date of the first transaction, and
transmit to the Facilitator user information regarding said offer.

14. The apparatus according to claim 13, wherein
the processing unit is further configured and/or programmed to forward said offer to the second user based on the Facilitator user input.

15. The apparatus according to claim 13, wherein
the processing unit is further configured and/or programmed to:
forward said second amount due and said second due date to a marketplace, wherein
said marketplace incudes at least one marketplace user,
said at least one marketplace user is not the first user,
said at least one marketplace user is not the second user, and
said at least one marketplace user is not the Facilitator user.

16. The apparatus according to claim 15, wherein
said at least one marketplace user accepts the offer,
the processing unit is further configured and/or programmed to:
inform the first user that the transaction is transferred from the second user to the Facilitator user and/or the at least one marketplace user, and/or
assign the transaction from the second user to the Facilitator user and/or the at least one marketplace user.

17. The apparatus according to claim 16, wherein
the Facilitator user and/or the at least one marketplace user having a Facilitator user account and/or a marketplace user account for receiving, holding and/or transferring funds,
the first user having a first user account for receiving, holding and/or transferring funds,
the second user having a second user account for receiving, holding and/or transferring funds,
the processing unit is further configured and/or programmed to:
transfer funds from the Facilitator user account and/or the at least one marketplace user account to said second user account on or prior to said second due date, wherein
said funds transferred from the Facilitator user account and/or the at least one marketplace user account to said second user account corresponds to said second amount due.

18. The apparatus according to claim 17, wherein
the processing unit is further configured and/or programmed to:
transfer funds from the first user account to said Facilitator user account and/or the at least one marketplace user account on or prior to said first due date, wherein
said funds transferred from the first user account to said Facilitator user account and/or the at least one marketplace user account corresponds to said first amount due.

19. The apparatus according to claim 13, wherein
the processing unit is further configured and/or programmed to:
send a different offer from the Facilitator user to said second user, wherein
the offer is a request to change the first amount due and the first due date of the first transaction to a third amount due and/or a third due date of the first transaction.

20. The apparatus according to claim 19, wherein
the third amount due is different from the second amount due, and
the third due date is different from the second due date.

21. A method comprising:
receiving account information separately from both a first user and a second user, wherein
the account information includes at least i) an information identification or invoice number ii) an amount of a commodity, iii) a due date corresponding to the amount of the commodity, iv) identification information of the first user and v) identification information of the second user;
matching the account information received from the first user to the account information received from the second user based on i) the information identification or invoice number, ii) identification information of the first user and iii) identification information of the second user;
assigning a transaction to the matched account information;
determining whether or not the amount of the commodity received from the first user numerically corresponds the amount of the commodity received from the second user;
determining whether or not the amount of the due date received from the first user corresponds the due date received from the second user;
assigning and/or labeling the transaction as an inaccurate transaction and sending:
a request for new commodity amount data in the case that a determination was made that the amount of the commodity received from the first user did not numerically correspond to the amount of the commodity received from the second user, and/or
a request for new due date information in the case that a determination was made that the amount of the due date received from the first user did not correspond to the due date received from the second user;
assigning and/or labeling the transaction as transaction in a case that both
a determination was made that the amount of the commodity received from the first user does numerically correspond to the amount of the commodity received from the second user, and
a determination was made that the amount of the due date received from the first user does correspond to the due date received from the second user,
searching a group of transactions based on a criterion that no offers are pending;
selecting a first transaction in said group of transactions based on a Facilitator user input, wherein
the first transaction includes a first amount due and a first due date,
receiving a second amount due based on the Facilitator user input;
receiving a second due date based on the Facilitator user input; and
sending an offer to the second user with the second amount due and the second due date, wherein
the second amount due is different than the first amount due, and
the second due date is different than the first due date.

22. A non-transitory computer readable medium having instructions stored thereon, such that when the instructions are read and executed by one or more processors, said one or more processors is configured to perform the method according to claim 21.
